(19) United States
(12) Patent Application Publication
(10) Pub. No.: US 2025/0345744 A1
(43) Pub. Date: Nov. 13, 2025

(54) MEANS AND METHOD OF CAPTURING NUTRIENTS AND WATER FROM AIR

(71) Applicant: CITY UNIVERSITY OF HONG KONG, Kowloon (HK)

(72) Inventors: Steven WANG, Kowloon (HK); Zhenwen ZHANG, Kowloon (HK); Zhi ZHANG, Kowloon (HK); Qili XU, Kowloon (HK); Wenzhu LIN, Kowloon (HK)

(73) Assignee: CITY UNIVERSITY OF HONG KONG, Kowloon (HK)

(21) Appl. No.: 19/084,025

(22) Filed: Mar. 19, 2025

Related U.S. Application Data
(60) Provisional application No. 63/644,043, filed on May 8, 2024.

(51) Int. Cl. B01D 53/26; B01J 19/08; C02F 1/68; C05C 5/00; H02N 1/04

(52) U.S. Cl. CPC B01D 53/261; B01J 19/088; C02F 1/68; C05C 5/00; H02N 1/04; B01D 2257/80; B01D 2258/06; B01J 2219/0805; B01J 2219/0875

(57) ABSTRACT

There is disclosed a device and a system for capturing moisture and nutrients from the air, such as from fog, mist, and rain. In an aspect, the water and nutrient capture system (WNCS) includes a water harvester or a water converter, an electricity generator, and a discharge reactor. In another aspect, the system includes one or more fog-to-water converters (FWC) and a spark-type droplet-based electric generator (SDEG). In yet another aspect, the FWC is a spiky cylindrical hollow structure having a biphilic surface, for example, a hydrophilic pattern on a hydrophobic substrate. The disclosed device and system improve water collection efficiency by up to 85% while reducing material usage by up to 44.8%. Further, the device and system may be used to facilitate nitrogen fixation, collect water, generate electricity, and/or promote plant growth. Moreover, the device and system may be used in agriculture and horticulture, environmental remediation, and/or water harvesting.

### CROSS-REFERENCE TO RELATED APPLICATIONS

This is a U.S. non-provisional application, which claims the benefit of U.S. provisional application 63/644,043, filed on May 8, 2024. The contents of the prior application is hereby incorporated by reference herein in its entirety.

### FIELD

The present disclosure relates to a device and a system for capturing water and nutrients from the air. More specifically, the present disclosure relates to bio-mimicry devices relating to the collection of air borne moisture and for generating electricity.

### BACKGROUND

Human beings rely on nature to provide the essential resources for survival: food and water. Growing population, overconsumption, and climate change are depleting global water sources and jeopardizing food security. Although the agricultural advancements in the 20th century boosted crop yields and mitigated food shortages, the misuse of chemical fertilizers has taken a toll on the environment and human health. Also, water shortages have put 2 billion people worldwide in dire straits and greatly limited the region where crops can be grown, directly or indirectly leading to 690 million people still suffering from malnutrition.

Crops require water and fertilizers to grow. However, the shortage of freshwater limits the region where plants especially crops can be grown, and the misuse of chemical fertilizers imposes an enormous burden on the environment and human health. Nitrogen and water are essential nutrients for plants.

As the global population grows rapidly, there is a need for a device and system for putting more water and nitrogen into the soil to increase food production, especially for arid and barren areas. In order for the supply of nutrients to be self-sustaining, there is a need for a device and system that uses as little power from the grid as possible to supply water and fertilizers. The present disclosure is directed to overcoming these and other deficiencies in the art.

### SUMMARY

In an aspect of the present disclosure, provided is a device including one or more fog harvesting units, wherein the one or more fog harvesting units include a polymer material, wherein each fog harvesting unit includes a frame, the frame having a hollow cylinder shape, and wherein the frame further includes spikes, the spikes having a surface.

In some embodiments, the spikes have a width of about 1 mm and a length of about 10 mm.

In some embodiments, the surface of the spikes includes a patterned structure.

In some embodiments, the polymer material is hydrophobic and the patterned structure is a hydrophilic patterned structure, and the hydrophilic patterned structure includes a hydrophilic material. In some embodiments, the polymer material is hydrophilic and the patterned structure is a hydrophobic patterned structure, and the hydrophobic patterned structure includes a hydrophobic material.

In some embodiments, the patterned structure is a geometric pattern, said geometric pattern is a circular pattern and/or a triangular pattern; and wherein adjacent geometric patterns are separated by about 1.1 mm to about 3.0 mm.

In some embodiments, the hydrophobic contact angle is greater than 90° and the hydrophilic contact angle is less than 90°.

In some embodiments, the device further includes an electricity generator and a discharge reactor. In some embodiments, the electricity generator comprises a Kelvin water dropper having two conductive containers and two conductive rings. In some embodiments, the discharge reactor: (i) facilitates nitrogen fixation through high voltage electric breakdown in the air, thereby converting nitrogen into nitrogen oxides; and (ii) generates nitrate that dissolves in water, thereby providing nutrients for plant growth.

In an aspect of the present disclosure, provided is a system including: a water harvester configured to collect fog, said water harvester comprising one or more fog harvesting units and optionally a water tank; an electricity generator configured to harness the gravitational potential energy of water droplets and the triboelectric effect to generate electricity; and a discharge reactor configured to receive water and energy from the electricity generator and to achieve nitrogen conversion, promoting plant germination and growth.

In some embodiments, the fog harvesting unit includes a frame, the frame having a surface, wherein the frame is open to the passage of air; and wherein the surface of the frame comprises a patterned structure.

In some embodiments, the frame comprises a hydrophobic polymer material and the patterned structure comprises a hydrophilic material.

In some embodiments, the patterned structure comprises one or more geometric patterns; said one or more geometric patterns comprising a circular pattern, a triangular pattern, or a combination thereof; and wherein the one or more geometric patterns are spaced apart by about 1.00 mm to about 3.00 mm.

In some embodiments, the hydrophobic contact angle is greater than 90°. In some embodiments, the hydrophilic contact angle is less than 90°.

In some embodiments, the electricity generator comprises a Kelvin water dropper having two conductive containers and two conductive rings.

In some embodiments, the discharge reactor: (i) facilitates nitrogen fixation through high voltage electric breakdown in the air, thereby converting nitrogen into nitrogen oxides; and (ii) generates nitrate that dissolves in water, thereby providing nutrients for plant growth.

In some embodiments, the frame comprises a hollow cylinder shape and a plurality of spikes, wherein a surface of the plurality of spikes comprises a hydrophilic patterned structure, said hydrophilic patterned structure comprising one or more geometric patterns, said one or more geometric patterns comprising a circular pattern, a triangular pattern, or a combination thereof; and wherein the one or more geometric patterns are spaced apart by about 1.00 mm to about 3.0 mm.

In some embodiments, the hydrophobic contact angle is greater than 90° and the hydrophilic contact angle is less than 90°.

In some embodiments, the water harvester comprises employs a modular design comprised of multiple fog harvesting unit, allowing adaptability to various scales of mist collection.

### BRIEF DESCRIPTION OF THE FIGURES

Some examples of the present disclosure will now be explained, with reference to the accompanied drawings, in which:

FIG. 1 depicts a non-limiting example of a device as described herein, including a water harvester, an electricity generator, and a bioreactor; the water harvester including multiple fog harvesting units in the shape of a hollow cylinder with spikes having a biphilic surface.

FIG. 2 depicts a non-limiting example of a device as described herein.

FIG. 3 depicts a non-limiting schematic illustration of a water and nutrient capture system (WNCS) including a fog-to-water converter (FWC) and a spark-type droplet-based electric generator (SDEG) arranged in a vertical series configuration.

FIG. 4A depicts a non-limiting example of two sets of fog harvesters placed side-by-side, each of which include multiple fog harvesting units and support structures.

FIG. 4B depicts a non-limiting example of a fog harvesting unit having a spiky cylindrical hollow structure and a biphilic surface.

FIG. 4C depicts a non-limiting example of a fog harvesting unit made of a hydrophobic polymer material with a hydrophilic patterned structure on the surface.

FIG. 5A depicts graphic results of a computational fluid dynamics (CFD) simulation, demonstrating that the hollow cylinder with spikes design of the fog harvesting unit enhances internal air vortices to significantly increase the chances of small liquid droplets encountering the solid surface.

FIG. 5B depicts a bar graph of water collection rate for no hydrophilic surface, a circle or triangle pattern hydrophilic surface, or a full hydrophilic surface.

FIG. 5C depicts a graph of water collection rate for different fog collectors. Mesh: the aperture are 0.42 mm, 0.64 mm, 1.27 mm and 2.54 mm. Harp: the wire diameter is 0.3 mm and the spacing is 1-4 mm. Patterned mesh: the horizontal wire is superhydrophobic, and other parameters are same with mesh.

FIG. 5D depicts a bar graph comparing fog harvesting capability (FHC) of different fog collectors.

FIG. 6A depicts a non-limiting example of a schematic of an electricity generator, specifically a Kelvin water dropper.

FIG. 6B depicts a graph of the voltage difference of an SDEG at different water flow rates.

FIG. 7A depicts an image of a non-limiting example of a discharge reactor; and a graph of the concentration of NO₂ (ppm) produced by a discharge reactor over time (minutes).

FIG. 7B depicts a graph of absorbance vs. wavelength (nm), showing the FTIR test results of dissolved nitrate in the discharge reactor; and an image of the growth of mung bean seedlings cultured in sodium nitrate solution and deionized (DI) water.

FIG. 8A depicts a graph of the voltage difference when the SDEG produces a spark.

FIG. 8B depicts a graph of the positive effects of WNCS on nitrate production and improving pea growth and nutrients.

FIG. 9A depicts a non-limiting example of three sets of WNCS, each including a FWC of 0.6×0.6 m².

FIG. 9B depicts a non-limiting schematic diagram of 3D FWC subjected to vertical (y direction) fog flow.

FIG. 9C depicts a non-limiting example of the processing of a 3D fog harvesting unit.

FIG. 9D depicts a schematic diagram and PIV characterization of 3D FWC, 2D FWC single-layer, and 2D FWC (×2) double-layer subjected to fog flow from x and y directions. The size and circulation of vortex a is 0.56 cm and 22.5 cm²/s, respectively, and the size and circulation of vortex b is 1.14 cm and 33.8 cm²/s, respectively.

FIG. 9E depicts the PIV characterization for 3D FWC units encountering wind from y direction.

FIG. 9F depicts a graph of collected water of 3D FWC, single-layer and double-layer 2D FWCs with the size of 0.6×0.6 m² (wind speed: ˜1 m/s, fog flow rate: ˜5 L/h).

FIG. 10A depicts a non-limiting example of the biphilic surface of a FWC.

FIG. 10B depicts an SEM image of an example biphilic surface.

FIG. 10C depicts an energy dispersive spectroscopy (EDS) analysis of the biphilic surface, which shows the hydrophilic PDA region contains more oxygen, representing hydroxyl groups and the hydrophobic FEP region contains more fluorine.

FIG. 10D depicts an image of the contact angle of FEP, for example is 108±2°.

FIG. 10E depicts an image of the contact angle of PDA, for example is 35±1°.

FIG. 10F depicts images showing an example of the growth of a droplet on a vertical biphilic surface.

FIG. 10G depicts a bar graph of the water collection rate of blank (hydrophobic substrate), biphilic-1 (the width of hydrophilic spot is 0.5 mm with a spacing of 3 mm), biphilic-2 (the width of hydrophilic spot is 0.5 mm with a spacing of 2 mm) and full-cover hydrophilic surface.

FIG. 11A depicts modelling of the critical detachment radius of water droplets on vertical biphilic surfaces; side view and front view of a droplet on a vertical solid surface.

FIG. 11B depicts a graph of the comparison of theoretical and experimental values of droplet gravity for different hydrophilic spot widths.

FIG. 11C depicts an example of the contact line formed by a droplet with the biphilic surface.

FIG. 11D depicts a graph of the gravity and adhesion of droplets on the biphilic surface with hydrophilic spot spacing of 0.5-1.5 mm and n spots.

FIG. 11E depicts a graph of the comparison of theoretical and experimental values of critical detachment radii of droplets with different hydrophilic points.

FIG. 11F depicts an example schematic of droplets merging behavior for Layout IV.

FIG. 12A depicts an example illustration of the four layouts of biphilic surfaces classified based on droplet detachment behavior.

FIG. 12B depicts a graph of the gravity F_{g} and adhesion F_{adh} of a droplet on the vertical biphilic surface.

FIG. 12C depicts a graph of the R_{c} on the vertical biphilic surface with different spacing between hydrophilic spots.

FIG. 12D depicts a graph of the comparison of water collection rate between fog harvesting units with layout II and other layouts (error bars indicate ±SD).

FIG. 13A depicts a non-limiting example schematic illustration of SDEG achieving electricity generation and electric nitrogen fixation.

FIG. 13B depicts a schematic of the electrical characteristics of an example SDEG circuit. V_{L} and V_{R} are the voltage of left and right metal rings. R_{RL} and C_{RL} are the resistance and capacitance between the two metal rings, respectively. R is the resistance between the metal ring and surrounding environment. C stands for the capacitance of the equipotential metal ring and container as charge storers. Q_{L} and Q_{R} are the effective charges of each droplet on the left and right sides respectively. n_{d} is the number of droplets per second.

FIG. 13C depicts a graph showing the experimental value and exponential fitting curve of the voltage difference of SDEG at the flow rate of 0.25 mL/s.

FIG. 13D depicts a graph of the charging and discharging behavior of SDEG.

FIG. 13E depicts images of the dynamic variation of electric field intensity during the spark process simulated using COMSOL Multiphysics software.

FIG. 13F depicts a graph of the charging behavior using different electrode types.

FIG. 13G depicts graphs of the voltage difference and current under different electrode distances.

FIG. 13H depicts a graph of the charging time of one cycle of SDEG (blue bar) and concentration of nitrogen dioxide (NO₂) produced of different d after 1 hour (orange bar). The volume of the electric nitrogen fixation reactor is 25 mL.

FIG. 14A depicts a graph of the chemical path of the mechanism reactions generating nitric oxide (NO) and NO₂ from air during the spark.

FIG. 14B depicts a graph of the molecular dynamics simulation results of nitrogen fixation using SDEG (error bars indicate ±SD).

FIG. 14C depicts an image of an example spark nitrogen fixation reactor with a volume of 25 mL.

FIG. 14D depicts a graph of the changes in NO₂ concentration over time. Sampling pumps and NO₂ detectors are used for testing.

FIG. 15A depicts a graph of the concentrations of nitrate

$$( {NO}_{3}^{-} )$$

and nitrite

$$( {NO}_{2}^{-} )$$

produced by WNCS at different times of continuous operation.

FIG. 15B depicts a test card (JBL PROSCAN Color Card) for testing the concentration of nitrogen oxides dissolved in water. The concentrations of the nitrite and nitrate dissolved in water are 5.0 mg/L and 100 mg/L, respectively.

FIG. 16A depicts images of the stems and roots of peas cultured using the solution produced by WNCS (test group) vs. that cultured using deionized water (blank group) on the 5^{th} day. Scale bar, 2 cm.

FIG. 16B depicts a graph of the stem length of peas in the test group and the blank group. The peas in the test and blank groups were cultivated by WNCS and DI water, respectively. Ten pea seedlings were randomly selected for measurement every day.

FIG. 16C depicts a graph of the stem and root length statistics of peas in the test and blank groups on the 5^{th} day. P values are evaluated by independent samples t-test analysis.

FIG. 16D depicts images of the enhancement of wheat growth by WNCS; growth of wheat on the 5^{th} day. Scale bar, 2 cm.

FIG. 16E depicts a graph of the stem and root length statistics of wheats in the test and blank groups on the 5th day. P values are evaluated by independent samples t-test analysis.

FIG. 17 depicts a graph of the comparison of nutritional content of peas in test and blank groups.

FIG. 18A depicts an example schematic of the electric field enhancement for seed germination.

FIG. 18B depicts an image of seed germination under a high-voltage electric field.

FIG. 18D depicts an electric-field simulation diagram of flat electrode connected to a SDEG.

FIG. 19A depicts a graph of the germination rate of pea seeds with and without electric field stimulation for 12 h.

FIG. 19B depicts images of the germination of pea seeds without and with E-field.

FIG. 19C depicts a graph of the germination rate of stem and root of peas without and with E-field.

FIG. 19D depicts a graph of the germination rate of wheats without and with E-field.

FIG. 20 depicts a graph showing the energy conversion efficiency of WNCS.

FIG. 21 depicts an image of the potential of water and nitrate that could be produced by WNCSs constructed along the coastline of arid zones working for 3 hours per day (error bars indicate ±SD).

### DETAILED DESCRIPTION

In an aspect of the present disclosure, provided is a device including one or more fog harvesting units, wherein the one or more fog harvesting units include a polymer material; wherein each fog harvesting unit includes a frame, the frame having a hollow cylinder shape; wherein the frame further includes spikes, the spikes having a surface; and wherein the surface of the spikes includes a patterned structure.

In some embodiments, the polymer material is a hydrophobic material and the patterned structure is a hydrophilic patterned structure. In some embodiments, the polymer material is a hydrophilic material and the patterned structure is a hydrophobic patterned structure.

In some embodiments, the width of the spike is about 0.5 mm to 1.5 mm, including all ranges, subranges, and values therein. Non-limiting examples include about 0.5-0.7 mm, about 0.7-0.9 mm, about 0.9-1.1 mm, about 1.1-1.3 mm, about 1.3-1.5 mm, about 0.5-0.9 mm, about 0.7-1.1 mm, about 0.9-1.3 mm, about 1.1-1.5 mm, about 0.5-1.0 mm, about 1.0-1.5 mm, about 0.5, 0.6, 0.7, 0.8, 0.9, 1.0, 1.1, 1.2, 1.3, 1.4, or 1.5 mm, etc. In some embodiments, the width of the spike is about 1 mm.

In some embodiments, the length of the spike is about 8 mm to about 12 mm, including all ranges, subranges, and values therein. Non-limiting examples include about 8-9 mm, about 9-10 mm, about 10-11 mm, about 11-12 mm, about 8-10 mm, about 10-12 mm, about 9-11 mm, about 8, 8.5, 9, 9.5, 10, 10.5, 11, 11.5, or 12 mm, etc. In some embodiments, the length of the spike is about 10 mm.

In some embodiments, the width of the spike is about 0.5 mm to about 2 mm and the length of the spike is about 8 mm to about 12 mm. In some embodiments, the width of the spike is about 1 mm and the length of the spike is about 10 mm.

In some embodiments, the patterned structure is a geometric pattern. In some embodiments, the geometric pattern includes circles and/or triangles. In some embodiments, the width of the geometric pattern is about 0.3 mm to about 0.7 mm, including all ranges, subranges, and values therein. Non-limiting examples include about 0.3-0.35 mm, about 0.35-0.4 mm, about0.4-0.45 mm, about 0.45-0.5 mm, about 0.5-0.55 mm, about 0.55-0.6 mm, about 0.6-0.65 mm, about 0.65-0.7 mm, about 0.3-0.4 mm, about 0.4-0.5 mm, about 0.5-0.6 mm, about 0.6-0.7 mm, about 0.3-0.5 mm, about 0.5-0.7 mm, about 0.3 mm, about 0.4 mm, about 0.5 mm, about 0.6 mm, about or 0.7 mm, etc. In some embodiments, the width of the geometric pattern is about 0.5 mm.

In some embodiments, the geometric patterns are separated (for example, the circles and/or triangles are spaced apart) by about 1.10 mm to about 3.00 mm, including all ranges, subranges, and values therein. Non-limiting examples include about 1.1-1.5 mm, about 1.5-2.0 mm, about 2.0-2.5 mm, about 2.5-3.0 mm, about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mm, etc. In some embodiments, the geometric patterns are separated by about 1.37 mm to about 2.5 mm.

In some embodiments, the hydrophobic contact angle is greater than 90°. In some embodiments, the hydrophobic contact angle is greater than 108°. In some embodiments, the hydrophilic contact angle is less than 90°. In some embodiments, the hydrophilic contact angle is less than 35°. In some embodiments, the hydrophobic contact angle is greater than 90° and the hydrophilic contact angle is less than 90°. In some embodiments, the hydrophobic contact angle is greater than 108° and the hydrophilic contact angle is less than 35°.

In some embodiments, the device further includes an electricity generator and a discharge reactor. In some embodiments, the electricity generator comprises a Kelvin water dropper having two conductive containers and two conductive rings. In some embodiments, the discharge reactor: (i) facilitates nitrogen fixation through high voltage electric breakdown in the air, thereby converting nitrogen into nitrogen oxides; and (ii) generates nitrate that dissolves in water, thereby providing nutrients for plant growth.

In an aspect of the present disclosure, provided is a system including: a water harvester configured to collect fog, said water harvester comprising one or more fog harvesting units and optionally a water tank; an electricity generator configured to harness the gravitational potential energy of water droplets and the triboelectric effect to generate electricity; and a discharge reactor configured to receive water and energy from the electricity generator and to achieve nitrogen conversion, promoting plant germination and growth.

In some embodiments, the fog harvesting unit includes a frame, the frame having a surface, wherein the frame is open to the passage of air; and wherein the surface of the frame comprises a patterned structure.

In some embodiments, the frame comprises a hydrophobic material and the patterned structure comprises a hydrophilic material. In some embodiments, the frame comprises a hydrophilic material and the patterned structure comprises a hydrophobic material. In some embodiments, the hydrophobic material is a hydrophobic polymer material.

In some embodiments, the patterned structure is a geometric pattern. In some embodiments, the geometric pattern includes circles and/or triangles. In some embodiments, the width of the geometric pattern is about 0.3 mm to about 0.7 mm, including all ranges, subranges, and values therein. Non-limiting examples include about 0.3-0.35 mm, about 0.35-0.4 mm, about0.4-0.45 mm, about 0.45-0.5 mm, about 0.5-0.55 mm, about 0.55-0.6 mm, about 0.6-0.65 mm, about 0.65-0.7 mm, about 0.3-0.4 mm, about 0.4-0.5 mm, about 0.5-0.6 mm, about 0.6-0.7 mm, about 0.3-0.5 mm, about 0.5-0.7 mm, about 0.3 mm, about 0.4 mm, about 0.5 mm, about 0.6 mm, about or 0.7 mm, etc. In some embodiments, the width of the geometric pattern is about 0.5 mm.

In some embodiments, the geometric patterns are separated (for example, the circles and/or triangles are spaced apart) by about 1.10 mm to about 3.00 mm, including all ranges, subranges, and values therein. Non-limiting examples include about 1.1-1.5 mm, about 1.5-2.0 mm, about 2.0-2.5 mm, about 2.5-3.0 mm, about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mm, etc. In some embodiments, the geometric patterns are separated by about 1.37 mm to about 2.5 mm.

In some embodiments, the hydrophobic contact angle is greater than 90°. In some embodiments, the hydrophobic contact angle is greater than 108°. In some embodiments, the hydrophilic contact angle is less than 90°. In some embodiments, the hydrophilic contact angle is less than 35°. In some embodiments, the hydrophobic contact angle is greater than 90° and the hydrophilic contact angle is less than 90°. In some embodiments, the hydrophobic contact angle is greater than 108° and the hydrophilic contact angle is less than 35°.

In some embodiments, the electricity generator comprises a Kelvin water dropper having two conductive containers and two conductive rings.

In some embodiments, the discharge reactor: (i) facilitates nitrogen fixation through high voltage electric breakdown in the air, thereby converting nitrogen into nitrogen oxides; and (ii) generates nitrate that dissolves in water, thereby providing nutrients for plant growth.

In some embodiments, the frame comprises a hollow cylinder shape and a plurality of spikes, wherein a surface of the plurality of spikes comprises a hydrophilic patterned structure, said hydrophilic patterned structure comprising one or more geometric patterns, said one or more geometric patterns comprising a circular pattern, a triangular pattern, or a combination thereof; and wherein the one or more geometric patterns are spaced apart by about 1.00 mm to about 3.00 mm.

In some embodiments, the width of each spike is about 0.5 mm to 1.5 mm, including all ranges, subranges, and values therein. Non-limiting examples include about 0.5-0.7 mm, about 0.7-0.9 mm, about 0.9-1.1 mm, about 1.1-1.3 mm, about 1.3-1.5 mm, about 0.5-0.9 mm, about 0.7-1.1 mm, about 0.9-1.3 mm, about 1.1-1.5 mm, about 0.5-1.0 mm, about 1.0-1.5 mm, about 0.5, 0.6, 0.7, 0.8, 0.9, 1.0, 1.1, 1.2, 1.3, 1.4, or 1.5 mm, etc. In some embodiments, the width of each spike is about 1 mm.

In some embodiments, the length of each spike is about 8 mm to about 12 mm, including all ranges, subranges, and values therein. Non-limiting examples include about 8-9 mm, about 9-10 mm, about 10-11 mm, about 11-12 mm, about 8-10 mm, about 10-12 mm, about 9-11 mm, about 8, 8.5, 9, 9.5, 10, 10.5, 11, 11.5, or 12 mm, etc. In some embodiments, the length of each spike is about 10 mm.

In some embodiments, the width of each spike is about 0.5 mm to about 2 mm and the length of each spike is about 8 mm to about 12 mm. In some embodiments, the width of each spike is about 1 mm and the length of each spike is about 10 mm.

In some embodiments, the hydrophobic contact angle is greater than 90°. In some embodiments, the hydrophobic contact angle is greater than 108°. In some embodiments, the hydrophilic contact angle is less than 90°. In some embodiments, the hydrophilic contact angle is less than 35°. In some embodiments, the hydrophobic contact angle is greater than 90° and the hydrophilic contact angle is less than 90°. In some embodiments, the hydrophobic contact angle is greater than 108° and the hydrophilic contact angle is less than 35°.

In some embodiments, the water harvester comprises employs a modular design comprised of multiple fog harvesting unit, allowing adaptability to various scales of mist collection.

The present disclosure relates to a device that collects moisture from the air, such as fog, mist, rain, and the like. The collected water can be used to generate high voltage electricity and excite plasma discharge to achieve nitrogen fixation, thereby providing nutrients for plant growth. The present disclosure further relates to a system that directly captures the water and nutrients needed for crop growth from the air, such as from fog, mist, rain, and the like.

The device and system provide for sustainable nitrogen fixation, water harvesting, electricity generation, and plant growth in various application, such as agriculture, horticulture, environmental remediation, and water resource management.

The device and system may be used to facilitate nitrogen fixation, collect water, generate electricity, and/or promote plant growth. For example, the device and system may facilitate abiotic nitrogen fixation by converting nitrogen in the air into nitrogen oxides through high voltage electric breakdown in the discharge reactor, which process provides a source of nitrogen for plant growth. Further, the device and system may include a water harvester designed to collect moisture from the air, such as from fog, mist, and the like; and optionally a water tank for collecting rain. The device can be modular and may include one or more fog harvesting units, which allows for adaptability to various scales of moisture collection. Moreover, the device and system may include an electricity generator, and the electricity generator may use the gravitational potential energy of water droplets and the triboelectric effect to generate electricity. The device may include a concise and low-cost Kelvin water dropper to generate electrostatic potential differences. Additionally, the device and system may include a discharge reactor for nitrogen conversion. By providing water and energy to the discharge reactor, nitrogen oxides are released and nitrates are formed, the nitrates serving as nutrients for plants.

The device and system may be used in agriculture and horticulture, environmental remediation, and/or water harvesting. For example, the device and system may be used in agricultural and horticultural settings to provide a sustainable source of nitrogen for plant growth. Further, the device and system may be used to enhance crop productivity and reduce the reliance on traditional nitrogen fertilizers. Moreover, the device and system may be used to convert nitrogen in the air into nitrogen oxides that can be used for environmental remediation purposes, such as the nitrogen deficiency in ecosystems or areas with poor soil quality. Additionally, the device and system can be applied in regions with limited water resources to help collect and store water from mist, rain, fog, etc. for various uses, including irrigation and drinking water supply.

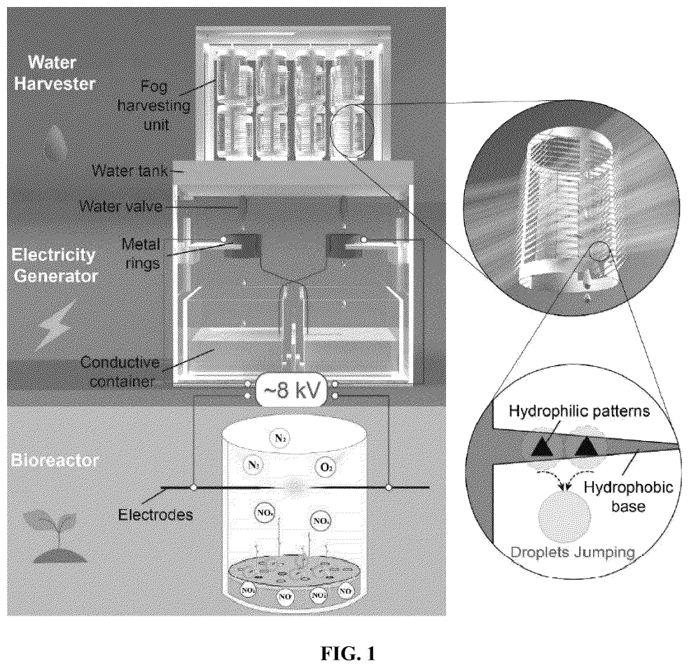

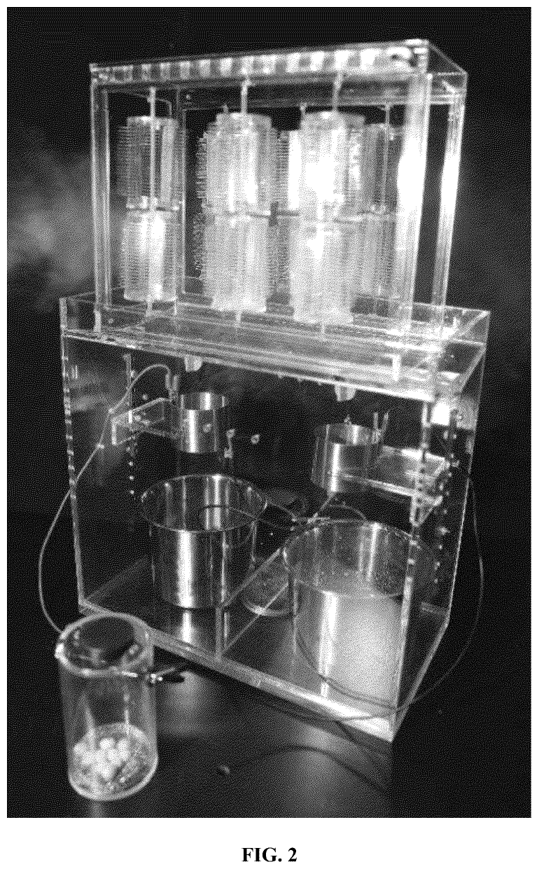

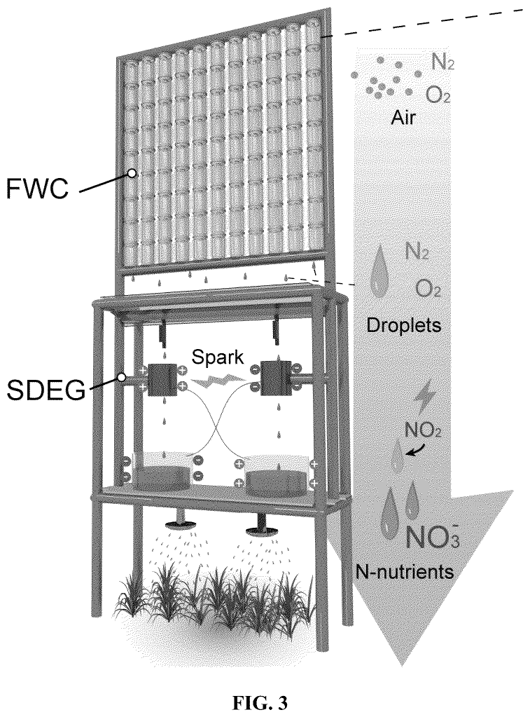

The system, or water and nutrient capture system (WNCS), may include a water harvester, an electricity generator, and a discharge reactor (see, for example, FIG. 1 and FIG. 2). The water harvester, or water converter, may be a fog-to-water converter (FWC). The electricity generator may be an electric generator such as a spark-type droplet-based electric generator (SDEG), for example, a Kelvin water dropper. The discharge reactor may be a bioreactor. The FWC and SDEG may be arranged in a vertical series configuration (FIG. 3). The system collects moisture from the air in order to provide water and nitrogenous nutrients for plant germination and growth.

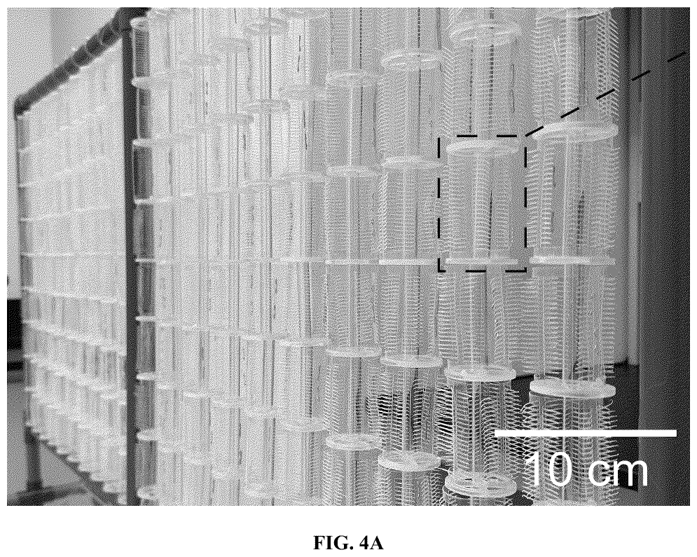

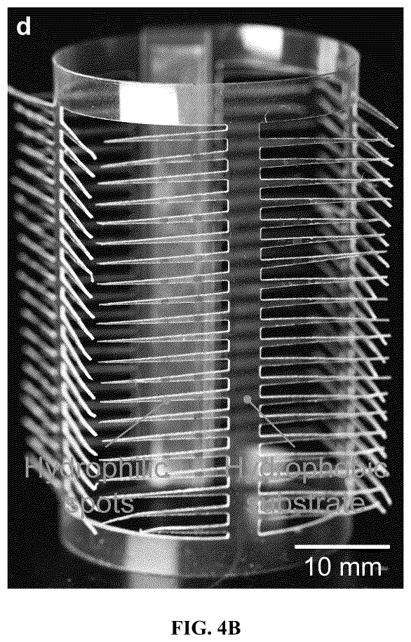

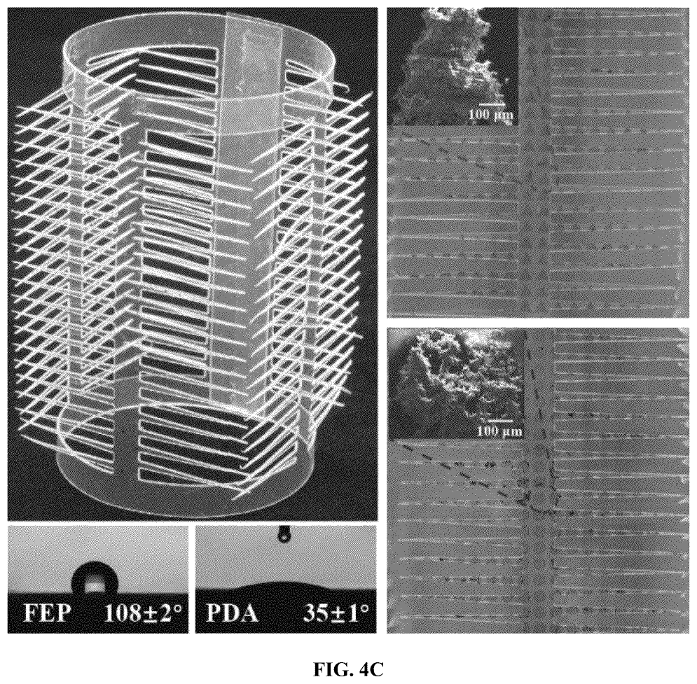

The water harvester or FWC may employ a modular design and consist of one or more fog harvesting units, thereby allowing adaptability to various scales of mist collection (FIG. 4A). Each fog harvesting unit includes a spiky cylindrical hollow structure and a biphilic surface (for example, a hydrophilic pattern on a hydrophobic substrate or a hydrophobic pattern on a hydrophilic substrate) (FIG. 4B and FIG. 4C), which allows for a quick droplet detaching rate, thereby improving water collection efficiency, such as to about 35%. In an embodiment, the body of the fog harvesting unit is made of a hydrophobic material, such as a hydrophobic polymer material that has high mechanical strength and corrosion resistance to extend the service life; and the pattern is a hydrophilic pattern. In an embodiment, the body of the fog harvesting unit is made of a hydrophilic material; and the pattern is a hydrophobic pattern.

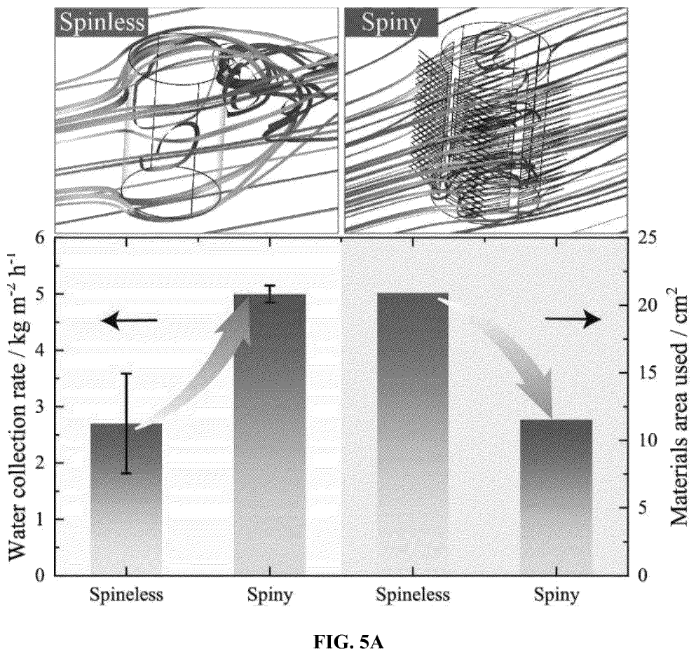

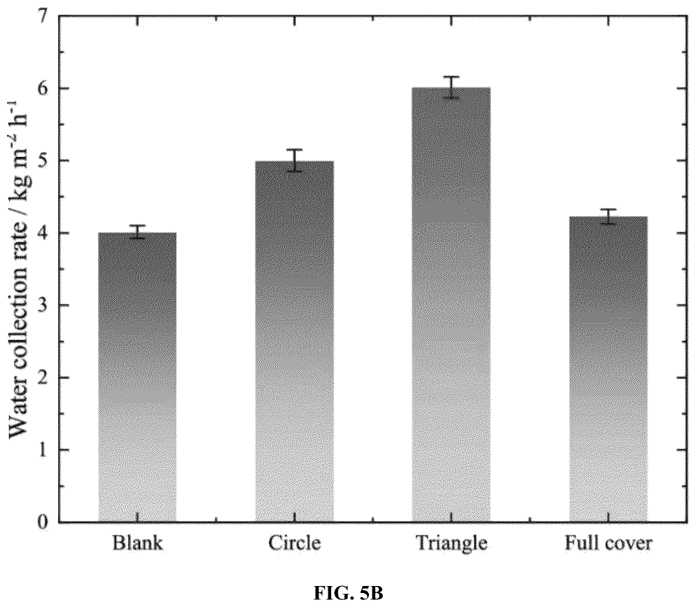

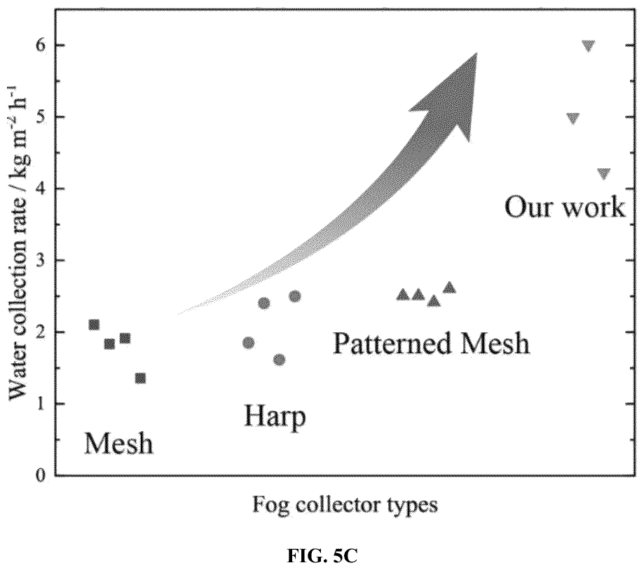

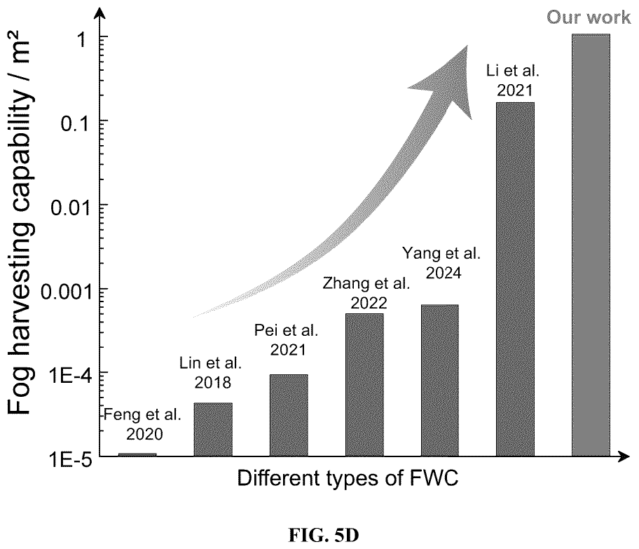

Further, the surface is designed with a hydrophilic patterned structure (FIG. 4C). In a non-limiting example, the hydrophobic contact angle is greater than 108° and the hydrophilic pattern has a contact angle smaller than 35°. In a non-limiting example, the hydrophobic contact angle is greater than 90° and less than 180°. In a non-limiting example, the hydrophilic contact angle is greater than 0° and less than 90°. Further, the hollow cylinder with spikes design of the fog harvesting unit enhances internal air vortices, significantly increasing the chances of small liquid droplets encountering the solid surface (FIG. 5A). This design improves water collection efficiency by 85.0% while reducing material usage by 44.8%.

By optimizing the geometrical dimensions and coverage area of the hydrophilic pattern, the probability of droplet jumping is increased, enhancing the rate of droplet detachment. The water collection efficiency is higher for structures with circular and triangular patterned surfaces compared to structures without hydrophilic patterns or fully covered hydrophilic materials (FIG. 5B). The highest water collection efficiency exceeds 6 kg/m²/h, significantly outperforming traditional mesh, harp, and patterned mesh structures (FIG. 5C).

The FWC geometric dimension may exceed 1 m through modular assembly. Considering both efficiency and scale, the fog harvesting capability of the FWC is an order of magnitude higher than other state-of-the-art works (FIG. 5D) A comparison of water collection efficiency and fog harvesting capability is summarized in Table 1, below.

FHC=η_{FWC}×A, where η_{FWC}=ν_{co}/ν_{de}, ν_{co} and ν_{de} are the water collection rate and the water delivery rate, respectively. A is the area of the FWC perpendicular to the fog direction. FHC indicates the application capability of FWC to harvest fog, which is an indicator of comprehensive scale and efficiency.

TABLE 1
Comparison of fog harvesting capabilities for different studies

| | Water collection | Geometric | Fog harvesting |
|---|---|---|---|
| Studies | efficiency/% * | dimension/m | capability/m² |
| Present Disclosure | 34.56 | 1.8 | 1.06 |
| Li et al. 2021 | 16.32 | 1 | 0.16 |
| Yang et al. 2024 | 39.90 | 0.04 | 6.38 × 10⁻⁴ |
| Zhang et al. 2022 | 20.27 | 0.05 | 5.01 × 10⁻⁴ |
| Pei et al. 2021 | 23.28 | 0.02 | 9.31 × 10⁻⁵ |
| Lin et al. 2018 | 1.72 | 0.05 | 4.29 × 10⁻⁵ |
| Feng et al. 2020 | 2.71 | 0.02 | 1.08 × 10⁻⁵ |

* water collection efficiency is the average value obtained

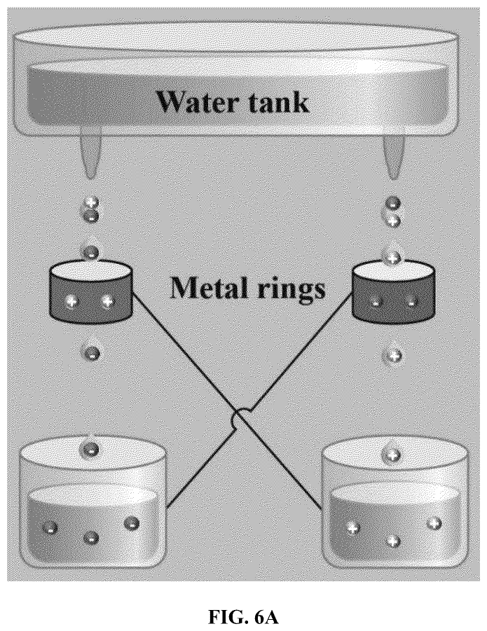

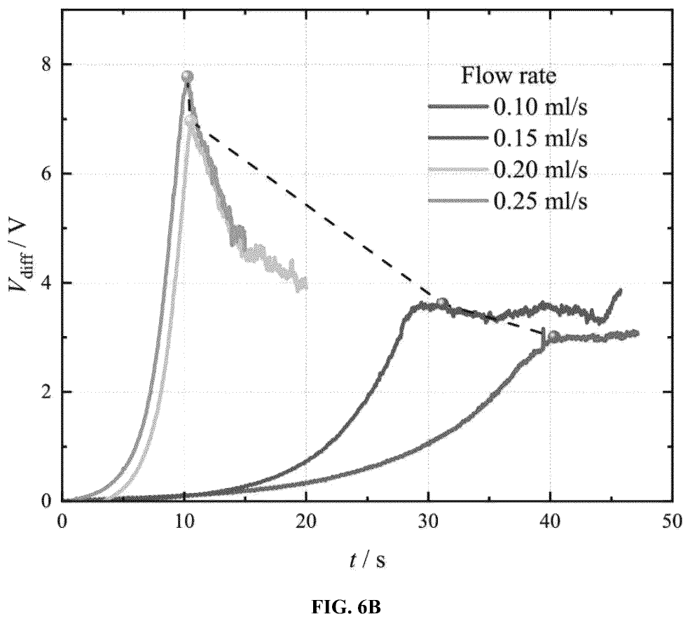

The Kelvin water dropper (which is concise and inexpensive) harnesses the gravitational potential energy of water droplets and the triboelectric effect to generate electrostatic potential differences, or electricity. The Kelvin water dropper only consists of two conductive containers and two conductive rings. Each conductive container is connected to a metal ring (FIG. 6A). When water is allowed to flow from the upper container to the lower container through the valves, the falling water droplets acquire positive or negative charges due to the triboelectric effect. This charge is transferred to the lower container, which becomes positively charged. Such a positive feedback loop allows the charge to accumulate rapidly. The highest voltage difference can reach approximately 8 kV under a water flow rate of 0.25 ml/s (FIG. 6B).

The high voltage electric breakdown in the air can facilitate nitrogen fixation, converting nitrogen in the air into nitrogen oxides. The related reactions are shown as Eqs. (a)-(d).

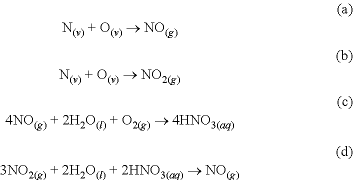

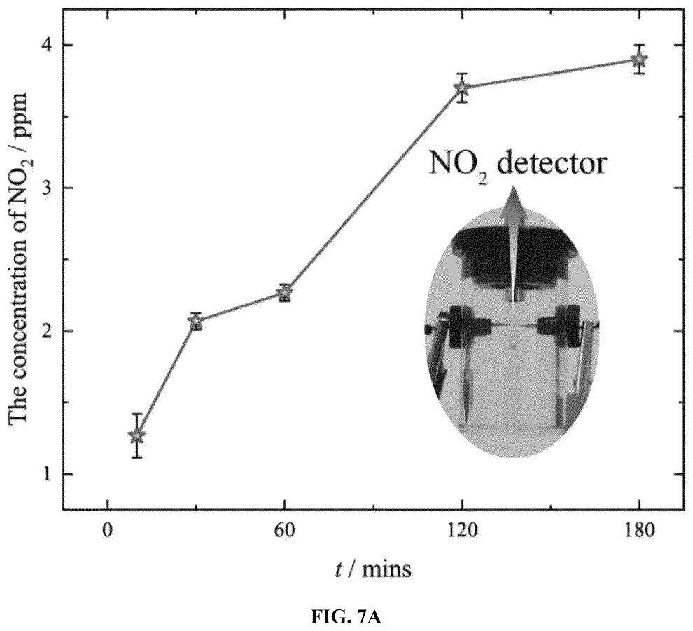

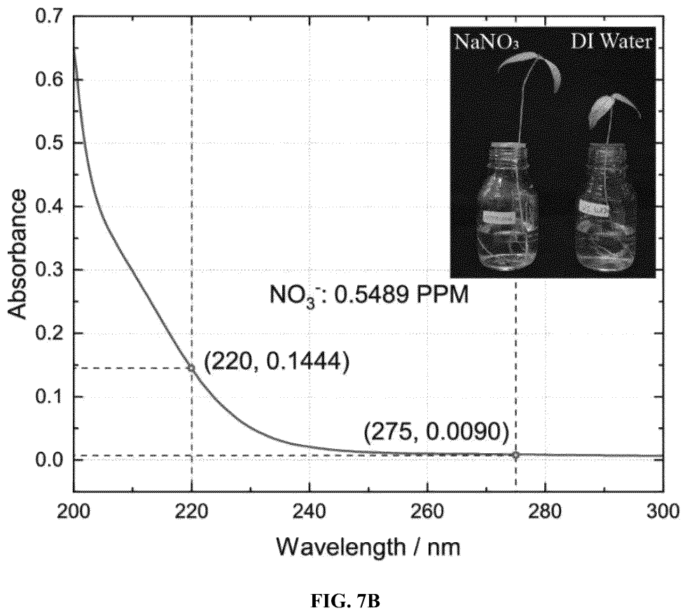

The electrical energy for the entire process comes from the upstream Kelvin water dropper, and no additional energy is required. A pair of electrodes can generate at least about 4 ppm of nitrogen oxides within about a 35 cm³ space during continuous discharge for about 3 hours (FIG. 7A). When nitrogen oxides dissolve in water to form nitrates, they provide nutrients for plant growth (FIG. 7B).

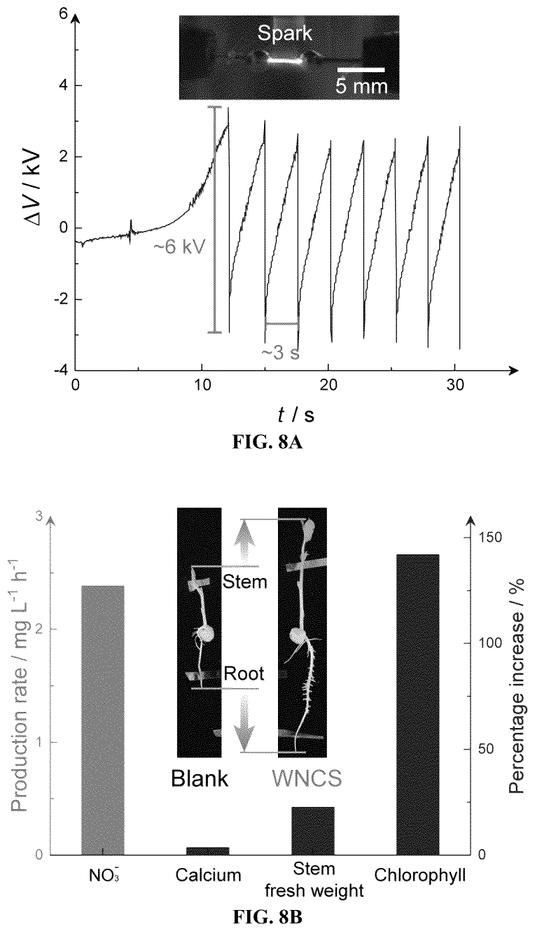

The SDEG can convert water droplets from FWC into a high voltage of 6 kV sufficient to generate electric spark (FIG. 8A). The electric sparks ionize the air every 3 seconds, and can yield nitrogen-based fertilizers at an average rate of 2.38 mg/L/h. Thus, the WNCS provides water and nutrients for crop growth without any additional energy input and pollutant emissions. Further, the WNCS greatly contributes to the growth of crops and improves its nutritional values, with stem fresh weight, calcium, and chlorophyll increased by 22.5%, 3.5% and 141.9%, respectively (FIG. 8B).

Fog harvesting technology has emerged as a promising solution to mitigate water scarcity, especially arid and semi-arid areas. The effectiveness of the fog harvesting process relies not only on efficient fog interception and condensation but also on rapid and stable droplet transportation. Despite numerous fog harvesting structures that have been developed, including mesh configurations, harp-shaped arrangements, as well as nature-inspired structures such as spider web-like structures, cactus-like structures, and beetle-like structures, it remains a challenge to achieve both high efficiency and large-scale application.

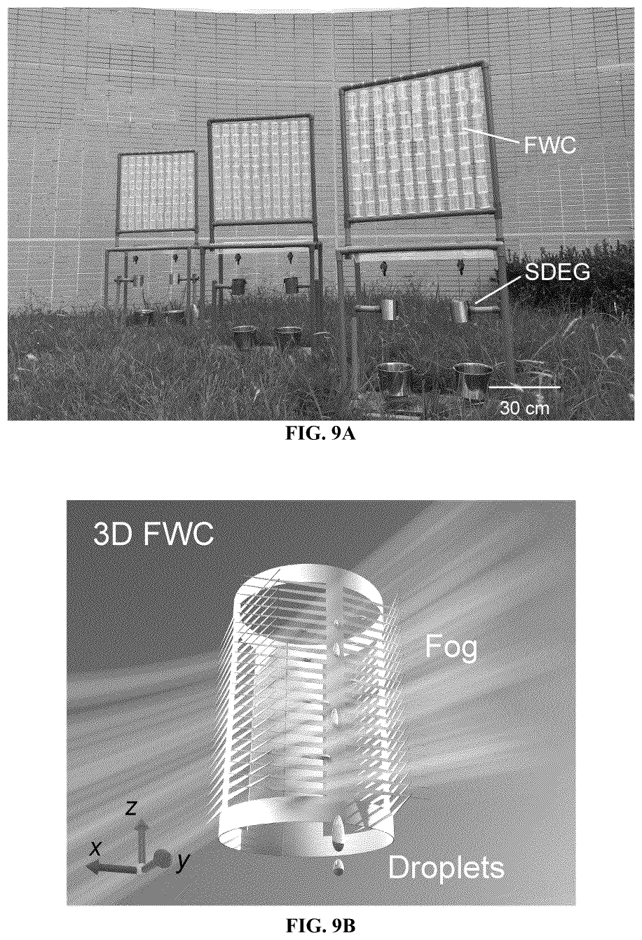

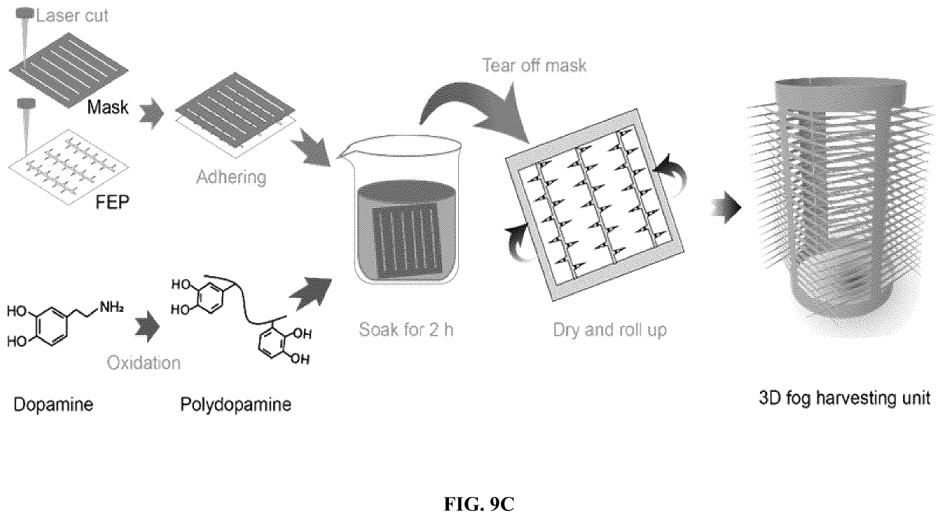

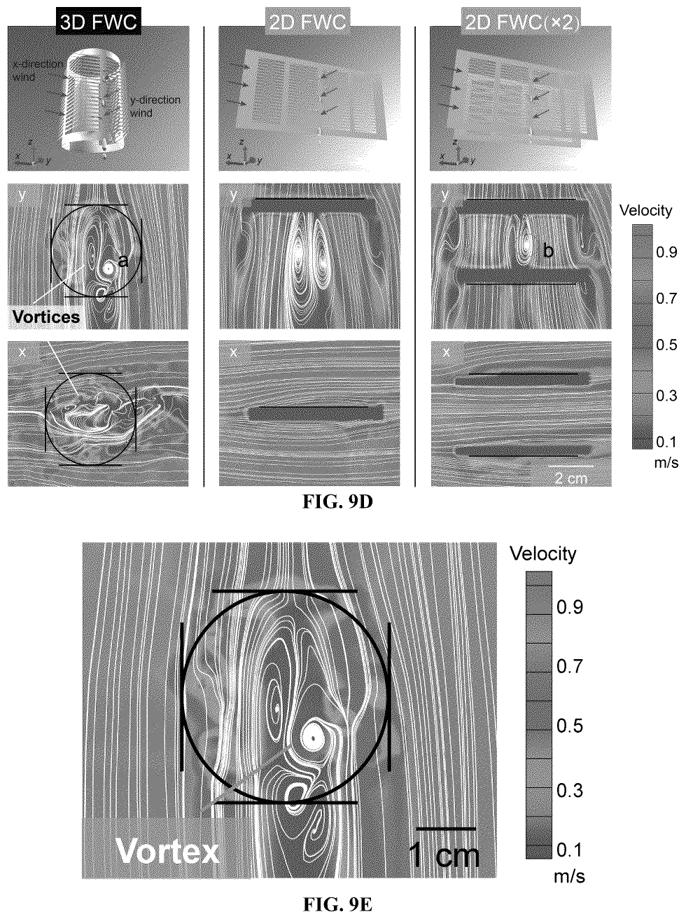

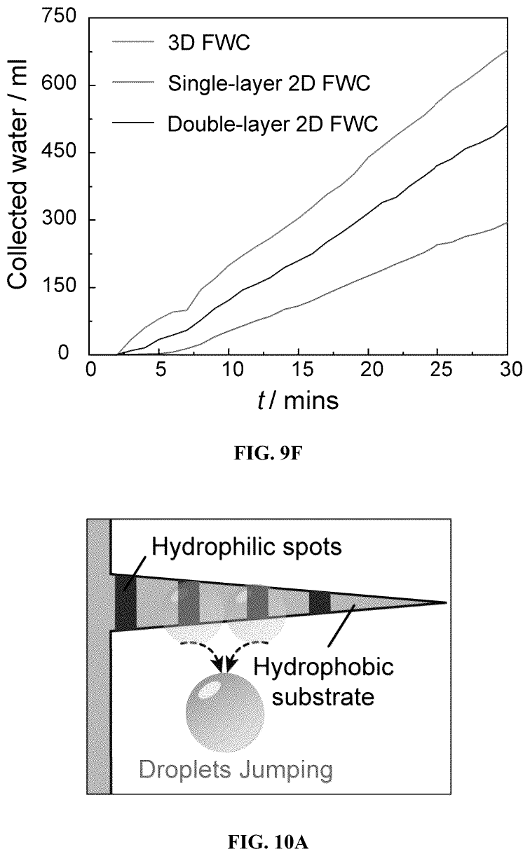

The present disclosure relates to a FWC including the 3D hollow cylinders of cacti and the hydrophilic and hydrophobic patterns on the back of beetles (FIG. 9A). The individual units in FWC were fabricated using laser cutting and curled into a three-dimensional (3D) spiky cylindrical hollow structure (FIG. 9B and FIG. 9C).

In terms of aerodynamics, the cylindrical structure of 3D FWC unit allows fog interception at omnidirectional fog flow, strikingly contrasting with the unidirectional fog flow required by raw 2D FWC (FIG. 9B and FIG. 9D). Intercepting common fog droplets efficiently is challenging due to their small size, ranging from 200 to 1250 nm, and their Stokes number (0.61-3.81) indicates that inertial force is not dominant. The Stokes number is given by St=ρ_{w}d_{w}μₐᵢᵣ/18 μₐᵢᵣ where d_{w} is the diameter of the fog droplets, μₐᵢᵣ is the velocity of air (here is 1 m/s) and μₐᵢᵣ is the dynamic viscosity of air. Because of this, most droplets are carried by the airflow and bypass the FWC unless vortices are generated, which can trap scattered small droplets in the vortex to form large droplets that can escape. The diameter of the droplet at the time of escape from the vortex, termed the critical escaping droplet diameter (d_{cri}), is determined by the air drag force (F_{D}) and centrifugal force (F_{C}). According to the “Burgers vortex” and droplet movement inside the vortex theory, F_{D}=3πd_{d}μₐᵢᵣuᵣ, where d_{d} is the diameter of droplet, μair is the dynamic viscosity of air and uᵣ is the velocity of the droplet relative to the fluid, and F_{C}=(d_{d}³ρ_{water}Γₒ²r_{ν}/36π≡⁴), where δ and Γₒ are the size and circulation vortex respectively and r_{ν} is the radial position. The relationship between them determines the motion of a droplet in a vortex. Hence d_{cri} be expressed as:

$${d}_{cri} = \frac{12 {πμ}_{air} δ}{{Γ}_{o} \sqrt{\frac{{ρ}_{air} {ρ}_{water}}{2}}} \qquad ( 1 )$$

In some embodiments, the fog harvesting unit is a 3D geometric structure in which the hollow portion allows the wind to flow through creating more internal vortices (FIG. 9E and FIG. 9D). The d_{cri} of the 3D FWC is about 6.75 μm according to δ and δₒ from the particle image velocimetry (PIV) measurement. Therefore, the fog droplets (d_{d}<d_{cri}) are carried into the vortex center by the air and gradually merge into large droplets. When F_{C}>F_{D}, the large droplet can escape and deposit on solid surfaces. This vortices enhancement effect hardly occurs in a single-layer 2D FWC (FIG. 9E) or double-layer 2D FWC (MEDF2) due to the limited vortices. The d_{cri} of a double-layer 2D FWC is about 36% higher than the 3D FWC, necessitating a longer fog droplet merging time in 2D FWC. Thus, the 3D FWC design is superior over conventional 2D configurations. Furthermore, the fog harvesting units can be assembled into large-scale applications, for example, by stacking units to build a fog harvesting array of about 0.36 m² (FIG. 9A), thereby achieving a water collection rate of approximately 0.67 L every 30 minutes (FIG. 9F). This represents a significant water collection improvement relative to single-layer and double-layer 2D FWCs.

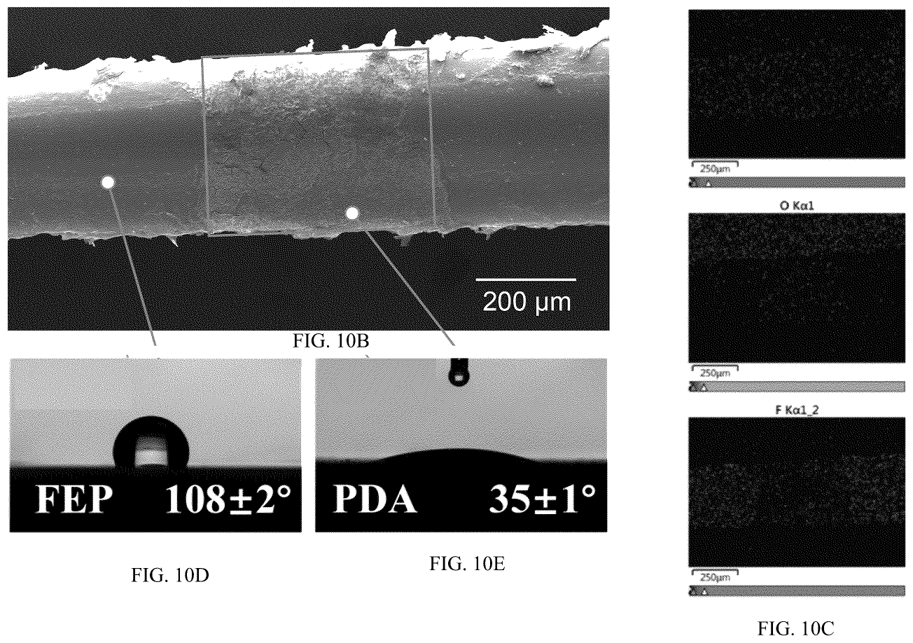

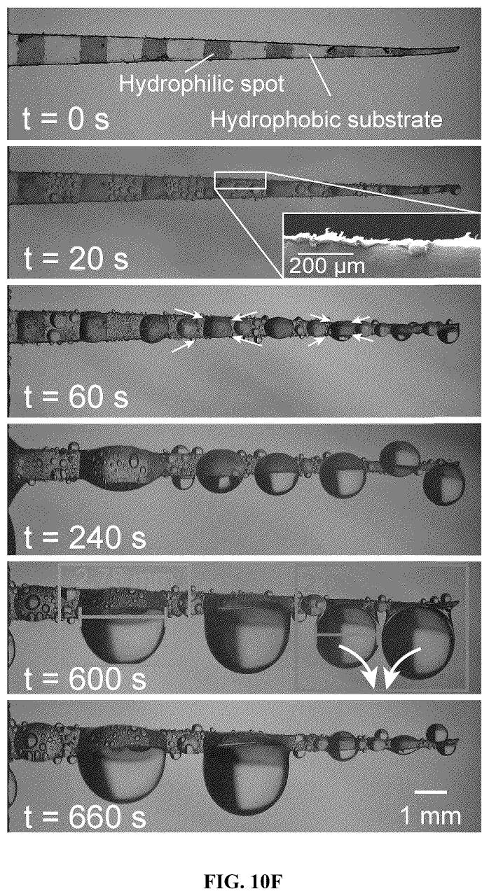

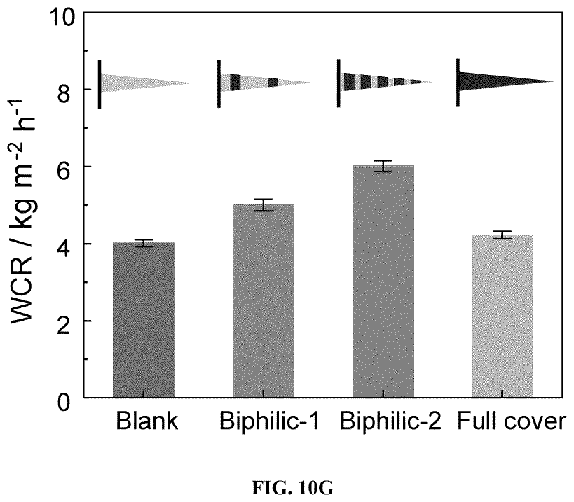

Another feature of the FWC is the biphilic surface (FIG. 10A, FIG. 10B, FIG. 10C, FIG. 10D, and FIG. 10E). In a non-limiting example, a mask method was applied to create an alternately arranged hydrophilic polydopamine coating on the hydrophobic fluorinated ethylene propylene surface (FIG. 9C). When fog flows around the biphilic spiky surface (FIG. 10F), it deposits on the wedged spine surface rapidly in the first few seconds and then merges into many small water droplets at the rough edges (˜1 μm in size) cut by the laser, with a noticeably faster rate on the hydrophilic regions. Subsequently, the water droplets on the hydrophilic spots absorb small droplets from adjacent regions, leading to rapid size growth. After about 600 s, two droplets merge and rapidly jump off the surface due to the suddenly increased weight. Notably, the detachment of the jumping droplet occurs earlier compared to droplets that merge prematurely, thereby allowing for a reduction in the critical detachment droplet diameter by approximately 0.72 mm (FIG. 10F). Furthermore, it facilitates the exposure of the solid surface, creating more available condensation sites for subsequent fog flows. Hence, the FWC with biphilic surface can obtain a higher water collection rate compared with completely hydrophobic or hydrophilic surfaces (FIG. 10G). Moreover, the spacing of hydrophilic regions has a significant effect on water collection. For example, a spacing of about 3 mm relative to a spacing of about 2 mm results in different water collection rates.

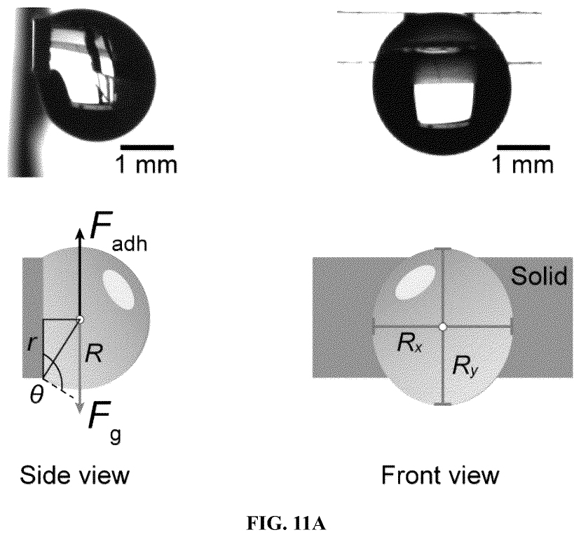

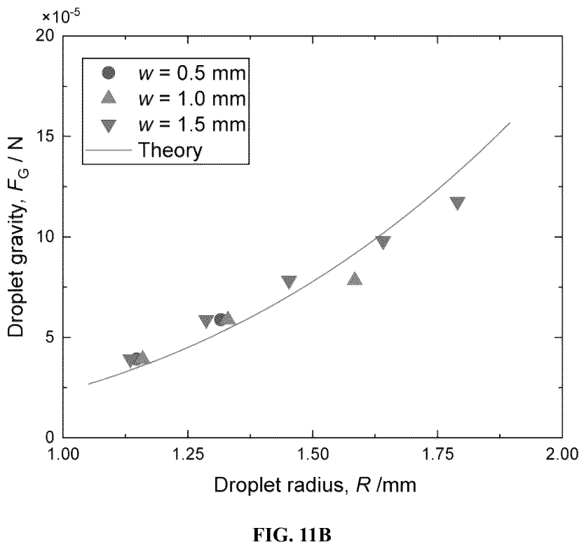

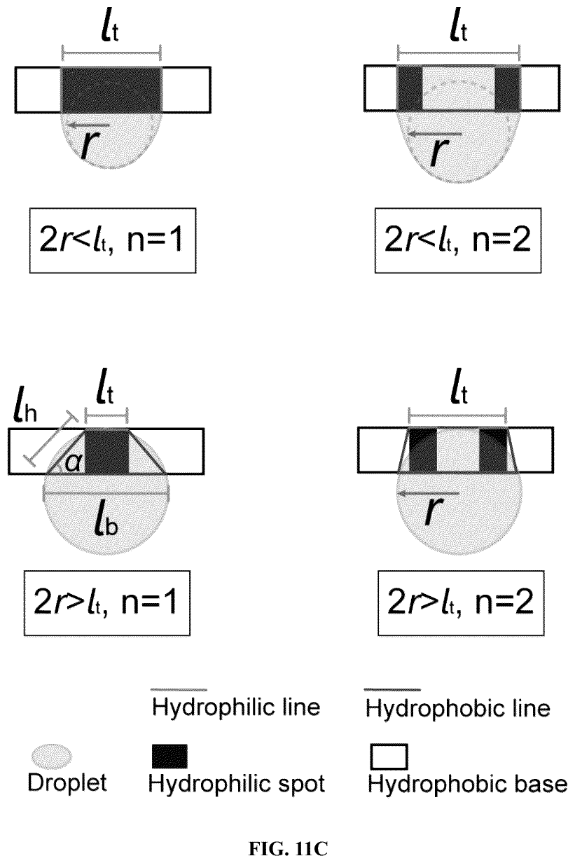

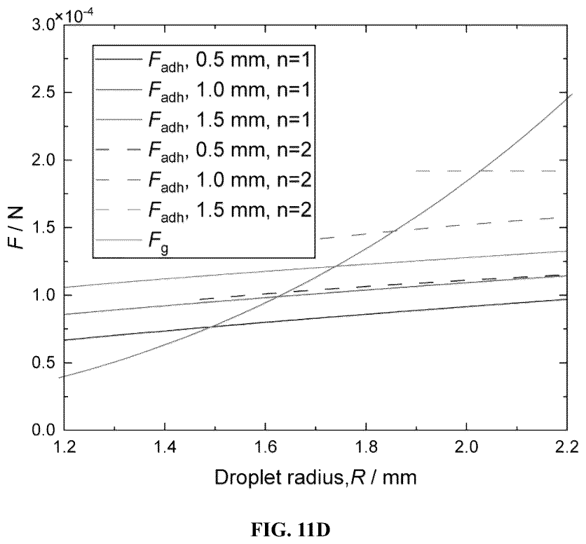

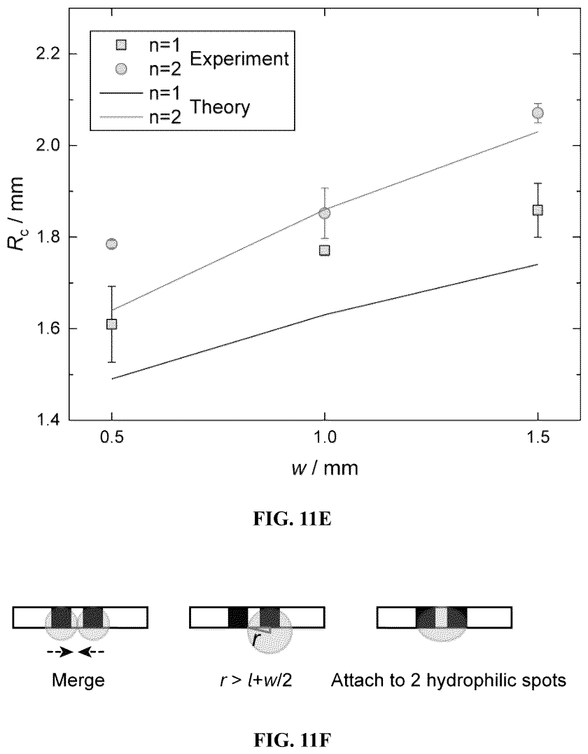

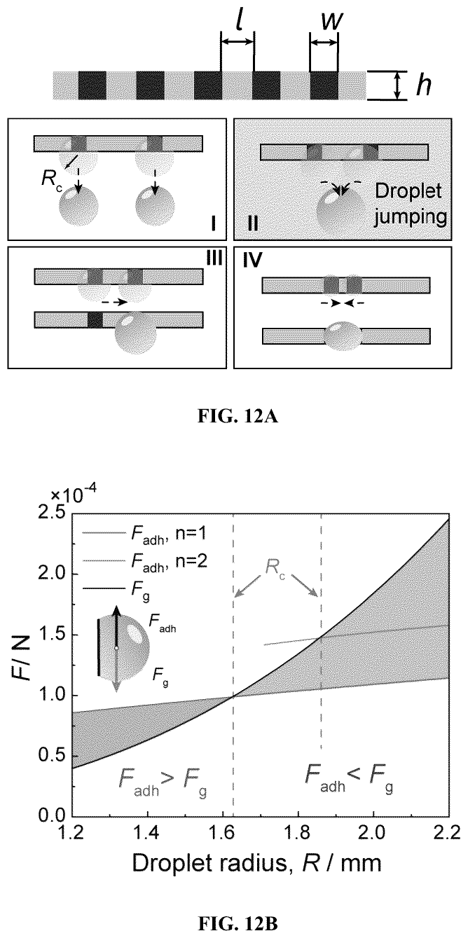

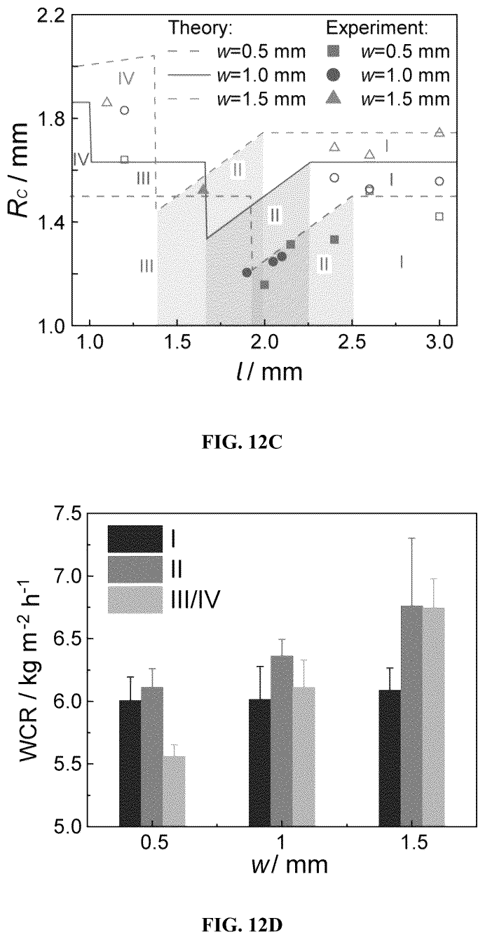

A theoretical model (FIGS. 11A-11F; Tables 2 and 3) was developed to examine the interplay between the gravitational force (F_{g}) and adhesion force (F_{adh}) of droplets (Eq. 3). In the model, the wedged spine was simplified as a rectangle shape, considering the proximity between two adjacent droplets (FIG. 12A) F_{g} was determined by the volume of droplets. The droplets adhered to the rectangular spine was shaped as spheres without spherical cap (FIG. 12B), by which F_{g} can be obtained. F_{adh} is the vertical component of the surface tension and was obtained by considering the polygonal contact line formed between the droplet and the solid interface.

TABLE 2
Advancing and receding contact angles of the droplets
on vertical hydrophilic and hydrophobic surfaces

| Contact Angles | Hydrophilic surface | Hydrophobic surface |
|---|---|---|
| Advancing | θ_{A}^{l} = 28.9° | θ_{A}^{b} = 111.9° |
| Receding | θ_{R}^{l} = 8.3° | θ_{R}^{b} = 83.1° |

The gravitational force and adhesion force are expressed as:

$${F}_{g} = {k}_{v} {ρ}_{water} {gV}_{droplet} \qquad ( 2 )$$

$${F}_{adh} = \{ \begin{matrix}{k}_{adh}^{′} [ nw cos ( {θ}_{R}^{l} ) + ( n - 1 ) l cos ( {θ}_{R}^{b} ) - {l}_{b} cos ( {θ}_{A}^{b} ) ] , h < r \leq \frac{{l}_{t}}{2} \\ {k}_{adh}^{″} [ nw cos ( {θ}_{R}^{l} ) + ( n - 1 ) l cos ( {θ}_{R}^{b} ) + 2 {l}_{h} cos ( {θ}_{R}^{b} ) cos ( α ) - {l}_{b} cos ( {θ}_{A}^{b} ) ] , r > \frac{{l}_{t}}{2}\end{matrix} \qquad ( 3 )$$

k_{ν} is the shape factor and is about 1.2 when corrected by the experimental data in this example (FIG. 11B). ρ_{water} is the density of water. V_{droplet} is the equivalent volume of the droplet on the vertical spine.

$${k}_{adh}^{′} and {k}_{adh}^{″}$$

are correction factors, and are about 0.35 and 0.60, respectively, in this example. γ is the surface tension of water. n is the number of hydrophilic spots contained in water droplets. l_{w} and lₕ are the width and height of hydrophilic points, respectively (FIG. 12A). lₜ, l_{b}, and lₕ are the length of the top, bottom, and hypotenuse, respectively, of the quadrilateral formed by the droplet in contact with the solid surface.

$${θ}_{R}^{l}$$

is the receding contact angle or the hydrophilic surface,

$${θ}_{R}^{b}$$

is the receding contact angle of the hydrophobic surface, and

$${θ}_{A}^{l}$$

is the advancing contact angle of the hydrophobic surface.

The critical detachment radius (R_{c}), which represents the radius of the droplet (before merging) when its F_{g}=F_{adh} may be determined. When a droplet is adhered to by two hydrophilic points, R_{c} increases significantly (FIG. 12B). Four example layouts were used to summarize the growth and detachment behavior of droplets on the vertical spiny biphilic surface (FIG. 12A). In layout I, the spacing between hydrophilic spots was comparatively large enough that a droplet could grow on a single hydrophilic region until it reached the critical size for detachment. In layout II, the spacing was decreased to ensure that the adjacent droplets could come into contact and merge during the growth process; and then jump off because the gravity of the merged droplet exceeds the adhesion force to the solid surface. In layout III, a droplet transferred to another droplet due to the close proximity, and then continued to grow until detachment. In layout IV, the spacing between hydrophilic spots was so close that the merging droplets were adhered by two hydrophilic spots.

Layout II can minimize R_{c} for different w (FIG. 12C). The experimental results indicate that R_{c} of layout II is smaller than that of other layouts. For example, if w=0.5 mm, R_{c} can be reduced by about 9.5%-21.8% compared to that on layout I when 1.9<l<2.5 mm (layout II). Fog harvesting units with Layout II have superior water collection rates (up to about 6.8 kg/m²/h) compared to fog harvesting units with other layouts (FIG. 12D). Under the same experimental conditions, the 3D FWC is about 2.3 times that of the traditional mesh structure (FIG. 5C) and the fog collection efficiency is more than about 35%.

In some embodiments, the spacing of the geometric pattern is in Layout II, the device collects the most fog water, and the spacing is in the range of about 1 mm to 3 mm, including all ranges, subranges, and values therein. For example, in some embodiments, the spacing is in the range of about 1.37 mm to 2.5 mm. In some embodiments, the width of the spike is about 1 mm. In some embodiments, the length of the spike is about 10 mm. In some embodiments, the geometric pattern is triangles.

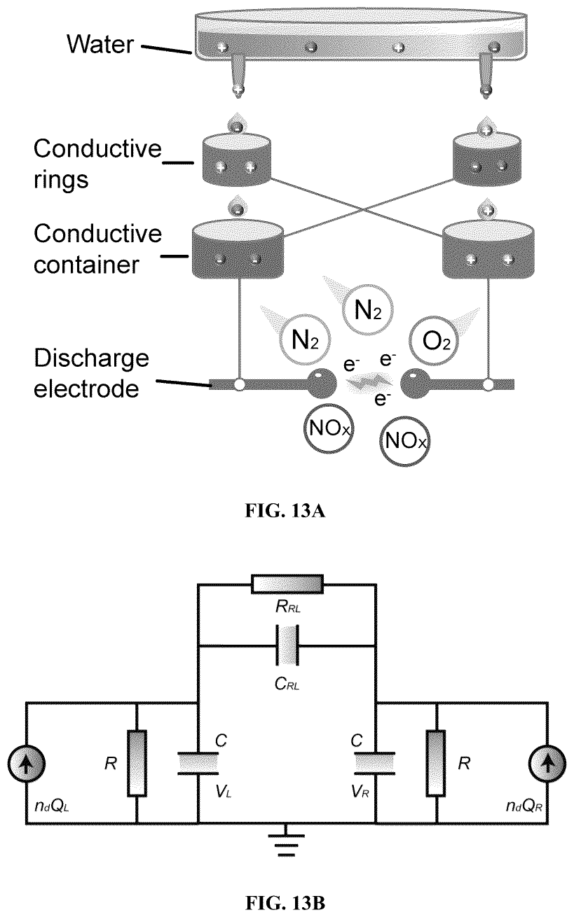

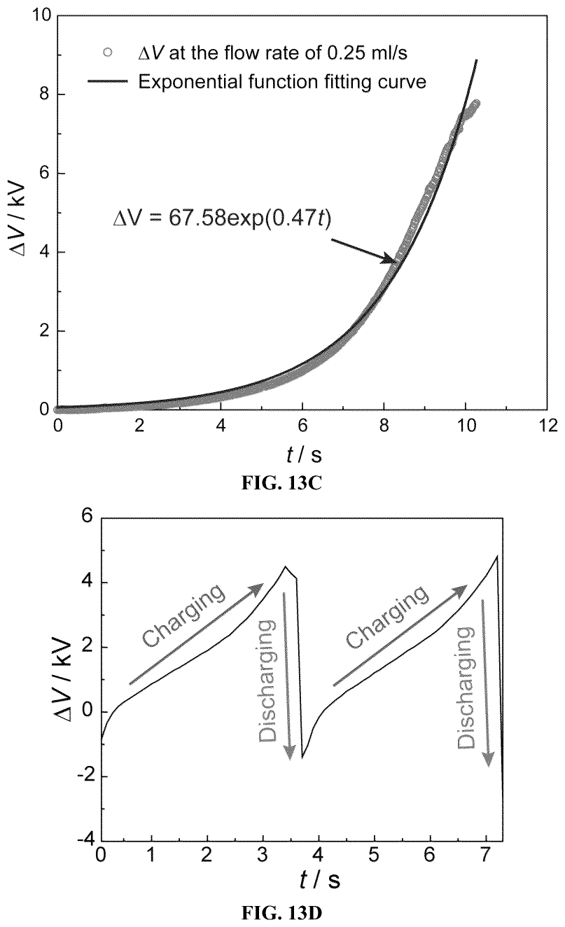

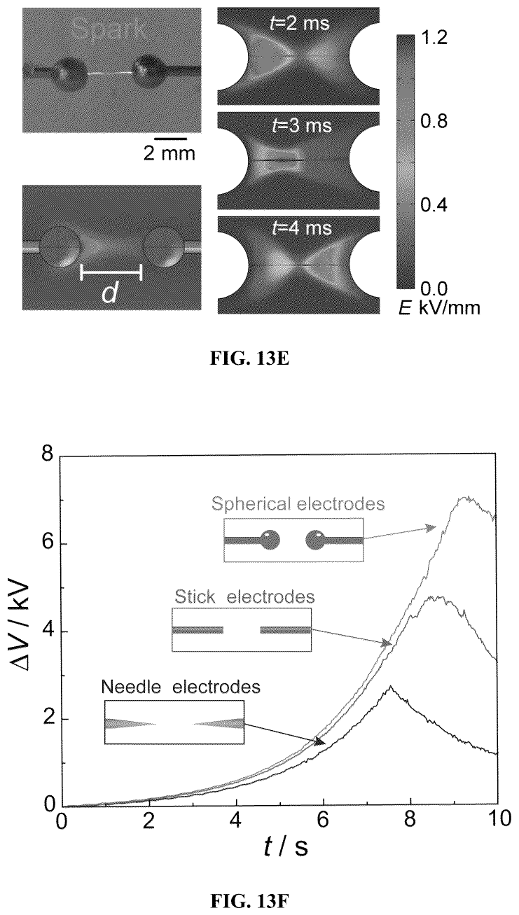

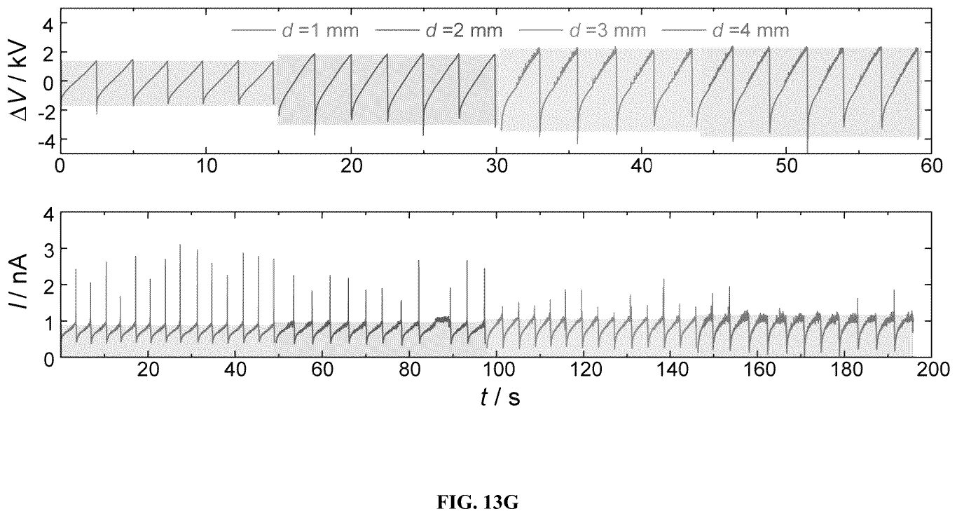

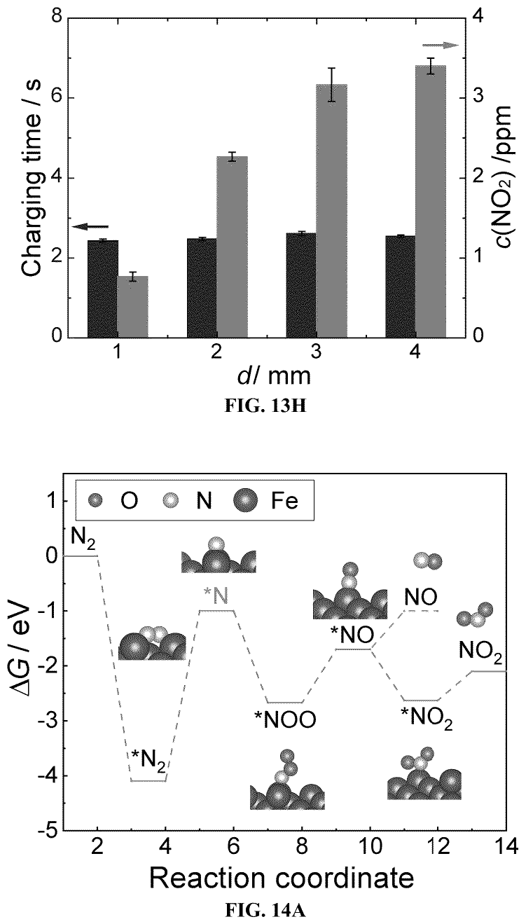

Given the output characteristics of high voltage and low current, an electrostatic generator was designed as the SDEG, which utilizes falling droplets from FWC to generate electric sparks through the electrostatic induction between interconnected systems with opposite charges (FIG. 13A). This is the first time to manipulate the spark from the electrostatic generator to produce nutrients from the air. The electric spark is induced by air breakdown, which can efficiently ionize the air and ultimately generate nitrogen-based nutrients required for crop growth. After simplifying SDEG into an equivalent circuit containing capacitors and resistors (FIG. 13B), it can be found that the relationship between voltage difference (ΔV) and time shows an exponential growth trend as:

$$Δ V ( t ) = \vert {V}_{L} - {V}_{R} \vert = 2 {V}_{0} exp \{ [ \frac{- ( 2 / {R}_{R L} ) - ( 1 / R ) + {n}_{d} {C}_{i}}{C + 2 {C}_{R L}} ] t \} \qquad ( 4 )$$

V_{L} and V_{R} are the voltage of left and right metal rings. V₀ is a constant determined by the initial state. R_{RL} and C_{RL} are the resistance and capacitance between the two metal rings, respectively. R is the resistance between the metal ring and surrounding environment. C stands for the capacitance of the equipotential metal ring and container as charge storers. Cᵢ is a capacitance between droplets before detachment and metal rings. n_{d} is the number of droplets per second.

ΔV(t)∝n_{d}, indicates the faster the droplets flow through the conductive ring, the faster ΔV rises. ΔV is proportional to the water flow rate given by the FWC (FIG. 6B). When the water flow rate is about 0.25 mL/s, the voltage difference can quickly rise to about 8 kV, and the change over time is according to the exponential function: ΔV=0.068 exp(0.47t) [kV] (FIG. 13C). The SDEG can be charged to the breakdown voltage in a short time of ˜3 s (FIG. 13D). During the discharge stage, where the charge is released rapidly and violently from the electrodes into the air, sparks are generated, thereby balancing ΔV of the system. The dynamical simulation (FIG. 13E) shows the variation in electric field intensity during the dynamic process from the initiation of spark at one end to the continuation of energy transfer. The local electric field strength is about 1.2 kV/mm, thereby providing a reliable source basis for subsequent energy conversion. The discharge process is related to the shape of the electrode. Compared with stick and needle-shaped electrodes, spherical electrodes can better save charge and achieve higher breakdown voltage (FIG. 13F). Depending on the voltage of the SDEG and the insulation level of air at about 3 kV/mm, the distance between the electrodes usually needs to be several millimeters. Both the breakdown voltage and current increase as the spherical electrode spacing d (FIG. 13G), thereby increasing the synthesis of NO₂ (FIG. 13H). Although the NO₂ concentration increased by about 343.8% from d=1 to 4 mm, the charging time only increased by about 0.11 s (4.61%) due to the exponentially increasing voltage (Eq. 4). Hence, it is preferable to maximize the electrode distance while ensuring the ability to discharge accordingly in practical applications.

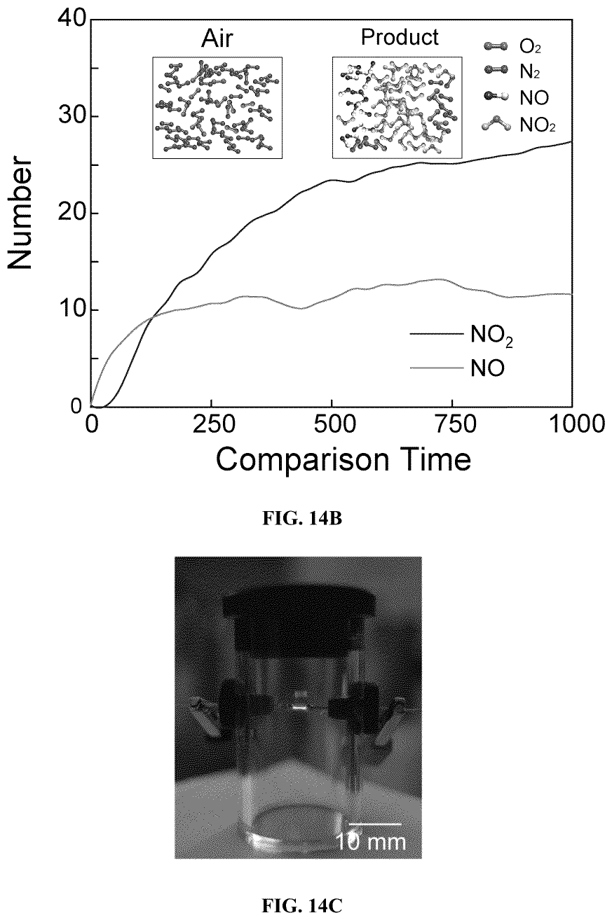

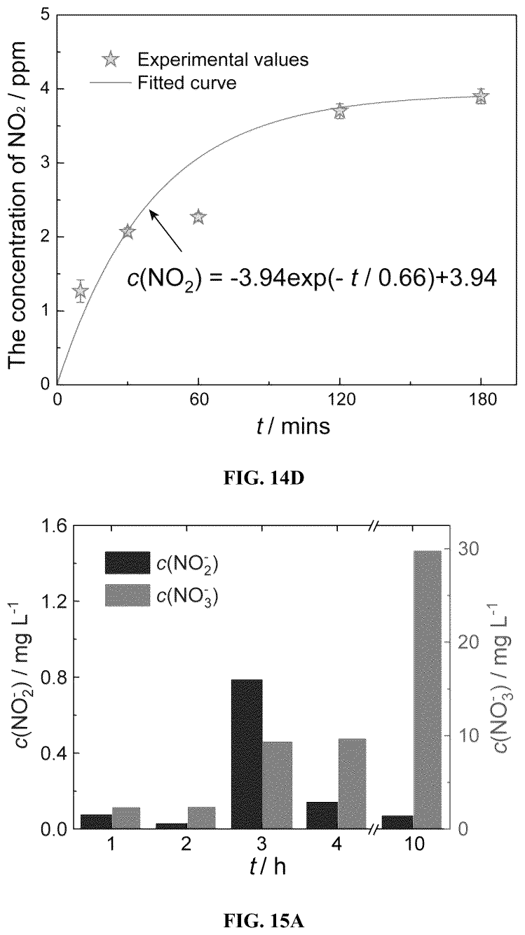

Unlike the high temperature and high pressure in the Haber process that consumes nearly 1-2% of the total global energy production, the WNCS does not require an additional energy supply. The nitrogen fixation mechanism is to release a large number of free electrons through the high-voltage discharge of SDEG. These electrons collide with nitrogen and oxygen molecules in the air and decompose into metastable substances such as N and O, and finally generate NO and NO₂ (Eqs. 5-8). The optimal reaction path of N₂/O₂-to-NO/NO₂ conversion and the optimized geometries are illustrated in FIG. 14A. Gibbs free energy (ΔG) landscapes show the conversion of the *N to *NOO to *NO and *NO₂. Moreover, the conversion of *NOO to *NO₂ displays a lower ΔG when compared to the ΔG of *NOO to *NO, indicating that during the transformation of nitrogen, *NOO transitions through *NO and subsequently spontaneously forms *NO₂. This process ultimately makes the generation of NO₂ easier than that of NO. Therefore, in the nitrogen fixation process via spark, the final concentration of NO₂ is higher than that of NO. Molecular dynamics was used to simulate the nitrogen fixation process during spark. The content of relevant gases in the original air and after nitrogen fixation is shown in FIG. 14B. During the spark, oxygen and nitrogen undergo transformation into NO and nitrogen dioxide NO₂ due to instantaneous high temperatures and intense ionization reactions. The changes in the concentrations of NO and NO₂throughout the spark process demonstrate that during the ongoing nitrogen fixation reactions, the final concentration of NO₂ significantly exceeds that of NO.

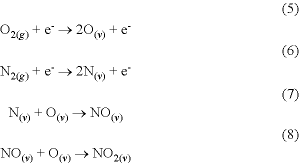

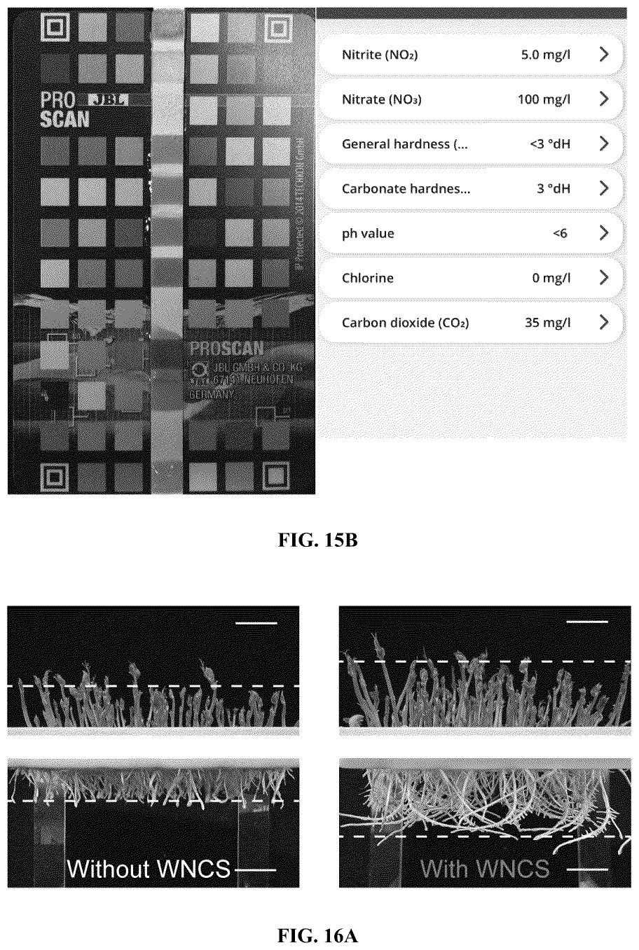

In the gaseous state, the average production rate of NO₂ produced by the 25 mL spark nitrogen fixation reactor is about 1.3 ppm/h (FIG. 14C and FIG. 14D). To cultivate plants, the nitrogen oxides produced are dissolved in water to form a culture solution. After being dissolved in the DI water, a culture solution rich in nitrate (NO₃⁻) and nitrite (NO₂⁻) ions is formed. The concentration of NO₃⁻ ions increased gradually with the reaction time and reached about 30 mg/L after about 10 h, while the concentration of NO₂⁻ ions stayed at a relatively low level of about <1 mg/L after about 10 h (FIG. 15A). When the WNCS was run for about 40 hours, it produced a culture solution containing about 100 mg/L NO₃⁻ (FIG. 15B).

### EXAMPLES

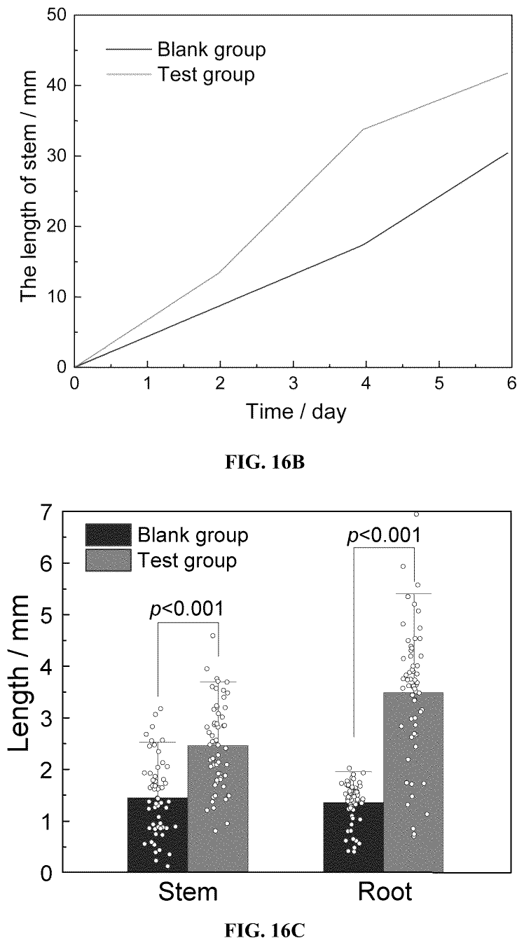

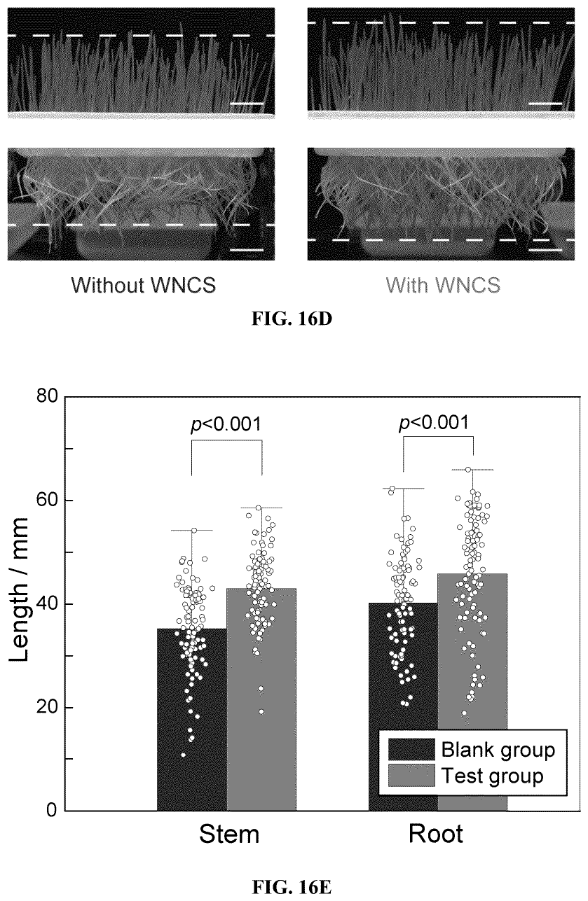

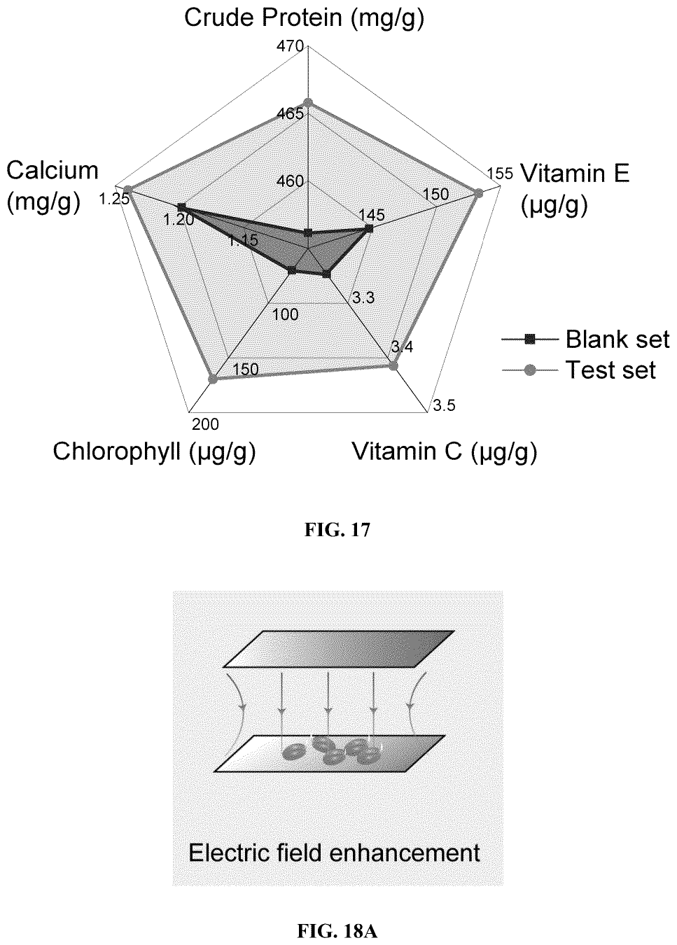

Peas, which have a fast growth rate, were used to evaluate the nitrogen fertilizer-based nutrient solution obtained directly from the air by the WNCS. Compared to the control group using deionized water as the culture medium, the growth of peas was significantly enhanced (FIG. 16A and FIG. 16B). The stem height increased by about 10.11%, and the root length increased by about 90.42% (FIG. 16C). It was visible to the naked eye that the root system of peas cultivated with WNCS was thicker and had more branches, which was beneficial for the plant's resistance to wind and drought. The growth of wheat under WNCS cultivation also showed the same promotion (FIG. 16D and FIG. 16E). Further, the nutritional content of peas cultivated by WNCS was enhanced, meeting the needs of living organisms more efficiently. The crude protein, vitamin E, vitamin C, calcium and chlorophyll increased significantly (FIG. 17).

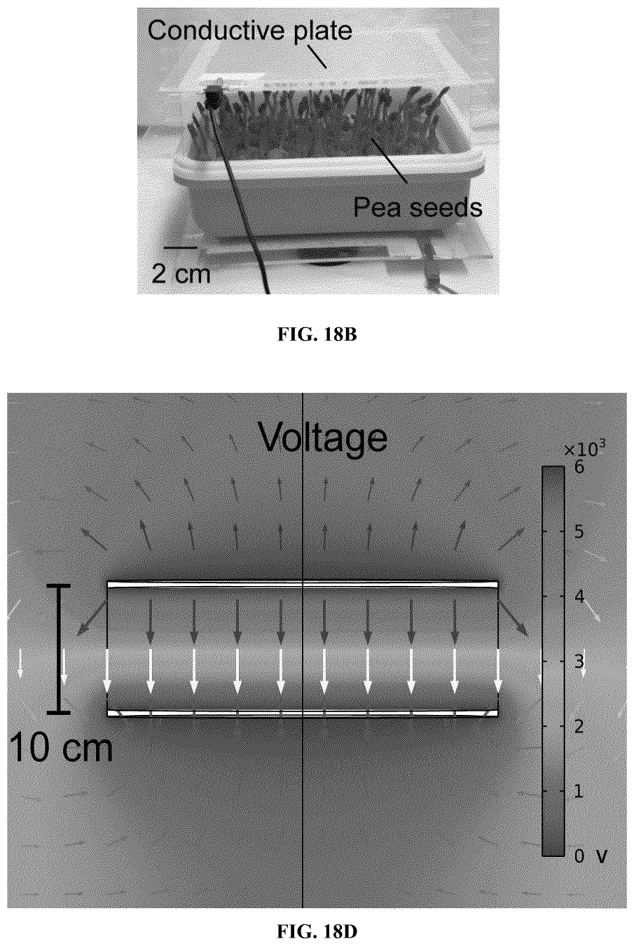

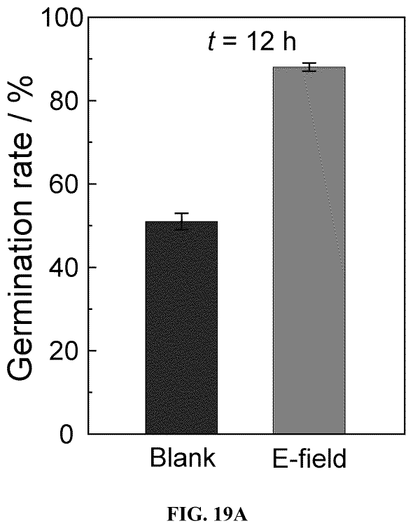

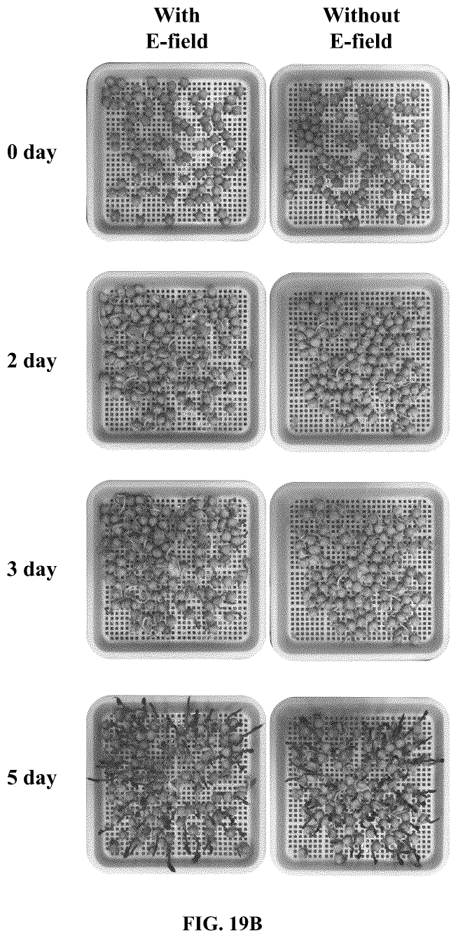

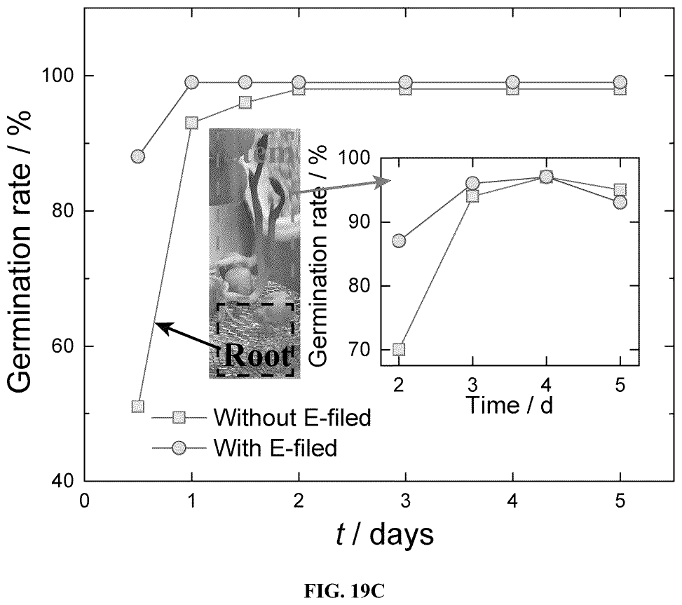

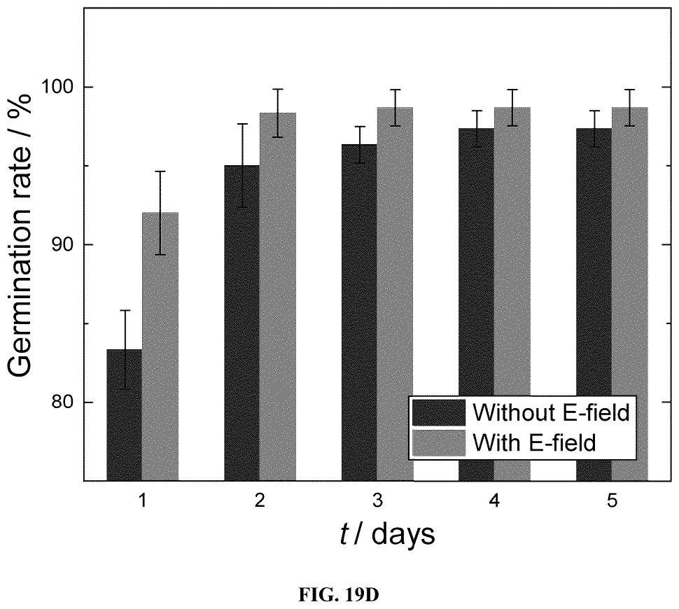

The WNCS can also adopt an electric field enhancement mode for promoting seed germination (FIG. 18A), which is crucial for crop yields. For example, the WNCS can provide an electric field of up to about 60 kV/m to the seeds by connecting the WNCS to two parallel conductive plates (FIG. 18B and FIG. 18C). Pea seeds with an electric field achieved about 88% germination rate after half a day, which was significantly better than that of a control group without electric field stimulation (FIG. 19A-19C). This was effective not only for peas but also for wheat seeds, which had germinated nearly a day earlier (FIG. 19D).

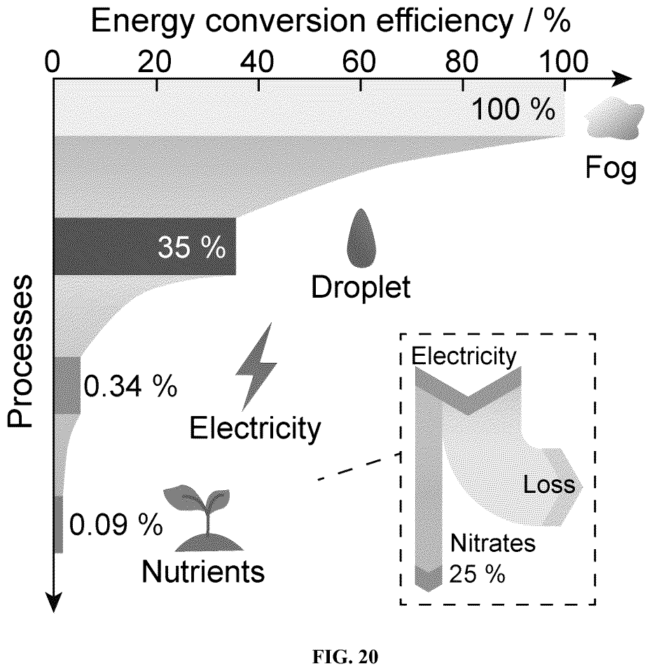

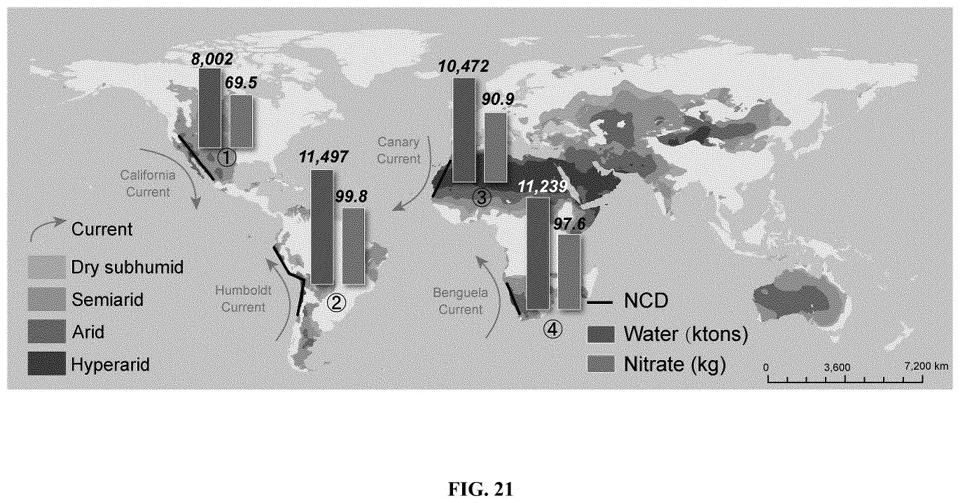

Overall, WNCS is a self-sufficient system that can realize multiple complex processes from fog harvesting to electricity generation to nutrient fixation. From the perspective of the energy conversion process (FIG. 20), the fog-to-water conversion achieves an efficiency of about 35%, and the water droplets overcome the electromagnetic induction force to do work, realizing the conversion of gravitational potential energy to electrical energy. Further, the high-pressure breakdown of the air achieved by the water droplets alone achieves about a 25% conversion of electrical energy to chemical energy. The nutrient harvesting potential of WNCS applications was comprehensively evaluated in four regions that are arid but foggy due to ocean currents. Deploying a 1-km WNCS every 1 m along the coastline of these areas and operating for 3 hours per day could provide up to about 11,239 kilotons of water and about 99.8 kg of nitrate to the arid areas (FIG. 21; Table 3). These water and fertilizer captured directly from the air was expected to increase global wheat production by approximately 1,407 kilotons per year. The WNCS effectively utilizes the coupled conversion of mechanical, electrical, and chemical energy, operating independently to capture nutrients from the air without additional energy input. This capability is expected to improve the ecological status of arid and barren lands by providing essential nutrients, thereby enhancing agricultural productivity and sustainability.

TABLE 3
Calculation of water and nutrients captured by WNCS

| | | | | | | Water | Nitrate |
|---|---|---|---|---|---|---|---|
| Se- | Fog flow | Coastline | FWC | Run | Nitrate | produc- | produc- |
| rial | rate/ | length/ | Height/ | time/ | yield/ | tion/ | tion/ |
| no. | g m⁻² h⁻¹ | m | m | h | mg h⁻¹ | ktons | kg |
| (1) | 740.8 | 2397922 | 5 | 3 | 0.0125 | 8001.7 | 69.4 |
| (2) | 740.8 | 3445605 | 5 | 3 | 0.0125 | 11497.8 | 99.8 |
| (3) | 1111.2 | 2092147 | 5 | 3 | 0.0125 | 10472.0 | 90.9 |
| (4) | 1296.4 | 1924775 | 5 | 3 | 0.0125 | 11239.9 | 97.6 |

### Methods

### Preparation and Testing of the fog Harvesting Units

The thickness of fluorinated ethylene propylene (FEP) film was 0.25 mm. Dopamine hydrochloride, Sodium periodate, sodium acetate, and acetic acid were purchased from Macklin.

The mask was first cut into a skeletonized shape using a laser cutter, and then the mask was adhered to a FEP film and cut with a laser to form a two-dimensional structure with spikes. The process to synthesize polydopamine was as follows: 100 ml of sodium acetate buffer with pH=5 was first prepared, then 0.2 g of dopamine hydrochloride was added, followed by 0.22 g of sodium periodate and stirred for 5 min. The cleaned FEP film was put into the solution and left to stand for 2 h, then it was cleaned with deionized water, dried in a vacuum drying oven, and torn off the mask. The 2D films were linked head to tail to form a 3D spiky cylindrical hollow structure.

To test the performance of the fog harvesting unit, a humidifier with a fan was used as a simulated fog source, and the sample was placed 10 cm away from the fog outlet. The wind speed was 1 m/s, and fog flow rate was 38 mL/h.

### The Definition of Water Collection Rate and Efficiency

The water collection rate is defined as the weight of water collected per unit area of fog-to-water converter per unit time:

$$W C R = \frac{{m}_{water}}{A t} \qquad ( 9 )$$

m_{water} is the weight of the collected water. A is the area of the FWC perpendicular to the fog direction (including the material-free part of the FWC). t is the running time of the FWC.

The water collection efficiency is defined as the interception rate of fog by the FWC, and the formula is as follows:

$${η}_{F W C} = \frac{{ν}_{c o}}{{ν}_{d e}} \qquad ( 10 )$$

ν_{co} is the water collection rate and ν_{de} is the running time of the FWC.

### PIV Measurement

The pulse laser used in PIV is Vlite-Hi-100 from Beamtech Optronics, the wavelength is 532 nm, the maximum frequency can reach 100 Hz, and the effective working area is over 180×180 mm². The CMOS camera used in PIV has a resolution of 2560×1600, a full-resolution frame rate of 800 Hz, and a minimum inter-frame time interval of 1.4 us. The inlet cross-section size of the low turbulence wind tunnel is 0.17×0.15 m². The turbulence is less than 0.08%.

### Modelling the Critical Detachment Radius of Water Droplets on Vertical Biphilic Surfaces

In the theoretical calculations, it was assumed that the droplet maintains a fixed contact angle θ on the vertical plane (FIG. 11A). The appearance geometry of the droplet was approximated as the remainder of a sphere minus the spherical cap (a portion of a sphere cut off by a plane). The volume and gravity of the droplet change relative to the radius R as in the following equations:

$${V}_{droplet} = {k}_{V} \frac{π}{3} [ 4 {R}^{3} - {h}_{d s}^{2} ( 3 R - {h}_{d s} ) ] \qquad ( 11 )$$

$${F}_{g} = {ρ}_{water} {V}_{droplet} g \qquad ( 12 )$$

kᵥ is the correction factor, which is about 1.2 in this example when corrected by the experimental data (FIG. 11B). R is the equivalent radius of a droplet, R=(Rₓ+R_{y})/2, Rₓ and R_{y} are the radii of the droplet in the horizontal and vertical directions, respectively. h_{ds} is the distance from the center of the droplet to the solid surface.

The adhesion force on vertical rectangular spines was calculated according to the contact angle of the droplet contact line and the surface tension, which is the combined force of the surface tension in the vertical direction. The following assumptions were made in the theoretical calculations:

(1) The droplet radius is larger than the width of the spines (w), because smaller droplets will not detach and there is no need to calculate the adhesion force.

(2) The contact angle of a droplet on a solid is fixed and does not change with droplet growth. In addition, the advancing and receding contact angles (θ_{A}, θ_{R}) of the droplets on hydrophilic and hydrophobic surfaces, obtained from experimental measurements, are shown in Table 2.

(3) The line of contact between the droplet and solid surface is considered as a straight line.

Accordingly, the adhesion of the vertical rectangular spines to the droplet (F_{adh}) is equal to the combined force of the droplet surface tension acting on the upper and lower contact lines (Eq. 3). F_{adh} is classified according to the size of the droplet and the distribution of hydrophilic spots. Firstly, when the diameter of the contact surface of the droplet with solid surface (2r) is less than the distance between the farthest edge of the hydrophilic spots (lₜ), the contact line approximately follows the edge of the hydrophilic spot. Secondly, the contact line forms an approximate isosceles trapezoidal shape, when r>lₜ/2. In addition, the contact angle of the upper contact line of the droplet is consistent with the surface wettability (FIG. 11C), i.e., the contact angle of the line of contact with the hydrophilic spots is

$${θ}_{R}^{l} .$$

The contact angle or lower contact line is approximated to be uniformly the advancing angle of the hydrophobic surface

$$( {θ}_{A}^{b} )$$

due to gravity.

Therefore, the adhesion force for droplets of different radii, and their relation to gravity, can be calculated (FIG. 11D). The value where F_{g} and F_{adh} are equal is the critical value for droplet detachment from the solid surface. The average errors of the results obtained according to the theory compared to the experimental results were 7.2% (n=1) and 3.1% (n=2) respectively (FIG. 11E).

Based on the above analysis, the critical detachment radius (R_{c}) that means the radius of the droplet (before merging) when its F_{g}=F_{adh} can be determined. The biphilic surface was divided into four layouts according to the droplet merging behavior (FIG. 12A); described above.

The critical hydrophilic spots spacing of the four layouts was determined as follows. Firstly, when a droplet grew to the maximum size of detachment at a single hydrophilic spot

$${R}_{max}^{n = 1} ,$$

the spacing at which two neighboring droplets could be made to just touch and merge was the critical spacing l_{I} between Layout I and Layout II, which is expressed by

$${l}_{I} = 2 {R}_{max}^{n = 1} - w .$$

Secondly, when the gravity of the large droplet after the merging of two small droplets was not enough to overcome the adhesion force, the large droplet would randomly jump to a hydrophilic spot and continued to grow until it was detached. Therefore, the boundary between Layout II and Layout III was the spacing l_{II} when the gravity of the large droplet was equal to the adhesion force. Thirdly, as the spacing continued to decrease and the edges of the merged large droplets touched the neighboring hydrophilic spot, the droplet would attach to the two hydrophilic spots (FIG. 11F). Thus, the boundary between Layout III and Layout IV could be expressed as lIII=\sqrt{r²−(r−h)²}−w/2. The size of the critical detaching droplets were calculated according to the different layouts of the droplets (Table 4).

TABLE 4
Critical detachment radius for different layouts

| | | Number of hydrophilic | Critical |
|---|---|---|---|
| | Relationship of F_{g} | spots included at the time | detaching |
| Layout | and F_{adh} | of detachment | radius |
| I | F_{g} > F_{adh} | n = 1 | ${R}_{c} = {R}_{max}^{n = 1}$ |
| II | F_{g} > F_{adh}* | n = 1 | ${R}_{c} = \frac{l + w}{2}$ |
| III | F_{g} < F_{adh}* | n = 1 | ${R}_{c} = {R}_{max}^{n = 1}$ |
| IV | F_{g} < F_{adh}* | n = 2 | ${R}_{c} = {R}_{max}^{n = 2}$ |

*F_{g} means that the gravity of the large droplet made up of two small droplets.

### Measurement of Electrical Characteristics of the Electrical Generator

Measurement of the voltage of SDEG was carried out using the electrostatic meter (ZEJING, JH-TEST) to observe the operation quickly and without interference. In addition, voltages were measured and recorded using the voltage divider method in conjunction with the oscilloscope (R&S®RTE1000). The current was measured using an electrometer (Keithley 6514) connected in series with the circuit.

### Dynamic Simulation of Spark Generation

To calculate the dynamic electric field dispersion, COMSOL 3D and 2D frequency domain simulations of the spherical electrodes were used, and physical field interfaces such as electric fields, electromagnetic waves, and dielectric electrics to simulate scenarios were used.

$$∇ J = - \frac{\partial t}{\partial {ρ}_{c}} \qquad ( 13 )$$

$$J = σ E \qquad ( 14 )$$

where J is the conservative current density, ρ_{c} is the density of charge, o is conductivity, and E is electric. ∇J represents the divergence of current density, reflecting the outflow or inflow of charge. A fixed local range of electric fields was setup to collect the electric field intensity between electrodes in millisecond order of time variation. Stainless steel electrode is considered to be the perfect conductor within the COMSOL database. There was an initial spark charging behavior of peak current at the upper, and then passed down.

### DFT Simulation

The Vienna Ab Initio Package (VASP) was employed to perform the density functional theory (DFT) simulation within the generalized gradient approximation (GGA) using the Perdew, Burke, and Enzerhof (PBE) formulation. The projected augmented wave (PAW) potentials were applied to describe the ionic cores and take valence electrons into account using a plane wave basis set with a kinetic energy cut off 400 eV. Partial occupancies of the Kohn-Sham orbitals were allowed using the Gaussian smearing method with a width of 0.05 eV. The electronic energy was considered self-consistent when the energy change was smaller than 10⁻⁵ eV. A geometry optimization was considered convergent when the force change was smaller than 0.05 eV/Å. Grimme's DFT-D3 methodology was used to describe the dispersion interactions. The vacuum spacing perpendicular to the plane of the structure is 15 Å. The Brillouin zone integral utilized the surfaces structures of 2×2×1 monk horst pack K-point sampling. Finally, the free energy was calculated using the equation:

$$Δ G = {E}_{a d s} + Z P E + T S \qquad ( 15 )$$

where ΔG, E_{ads}, ZPE and TS are the free energy, total energy from DFT calculations, zero-point energy and entropic contributions, respectively.

### MD Simulation

The MD calculations used the LAMMPS program with reactive force field ReaxFF and CHON-2019 parameters. The ReaxFF force field is a force field based on the bond order and the ReaxFF force field includes the following energy components:

$${E}_{syst} = {E}_{b o n d} + {E}_{o v e r} + {E}_{u n d e r} + {E}_{l p} + {E}_{v a l} + {E}_{tor} + {E}_{v d W a a l s} + {E}_{C o u l o m b} \qquad ( 16 )$$

where terms on the right-hand side of the equation represent bond energy, over-coordination energy penalty, under-coordination stability, lone pair energy, valence angle energy, torsion angle energy, van der Waals energy, and Coulomb energy, respectively.

The computational box was in the size of 32×32×32 nm³ with the periodic boundary conditions and contained approximately 600 atoms. The initial model added oxygen and nitrogen molecules in proportion to the air. NVT ensemble was used to control the temperature of the whole system with the timestep of 0.1 fs.

### Cultivation of Peas and Wheat

Pea and wheat seeds were soaked in water for at least 12 h prior to germination. The seeds were covered with moist paper for the first 1-2 days of germination, and the production process was carried out in a grid-like pot of water for cultivation.

To verify the effectiveness of nutrients produced by WNCS, the experimental and blank groups were grown in the same environment except for the different culture solution. The growth height was counted at regular intervals. When testing for electric field enhancement, the experimental group was subjected to the electric field enhancement device (FIG. 18B). Other conditions were the same as the blank group.

### Testing of Nutrient Produced by WNCS

Concentration of nitrogen dioxide in gases produced by WNCS using a nitrogen dioxide detector (EDKORS, ADKS-1) with sampling pump.

Concentrations of nitrate and nitrite followers in liquid nutrients produced by WNCS were tested by ion chromatography (IC). The IC instrument model was DIONEX AQUION, and column model is Dionex IonPac AS19, 4×250 mm. The detector was amperometric detector, and the potassium hydroxide concentration was 20 mmol/L. The column oven temperature was 30° C., the mobile phase flow rate was 1.0 mL/min, and the run time was 20 minutes. The suppression current was 60 mA, and samples were tested directly on the machine.

### Testing of Nutritional Content in Plants

Crude protein: The sample, fresh pea sprouts stems, was digested with sulfuric acid under the action of a catalyst, and the nitrogen-containing compounds were converted into ammonium sulfate. Ammonia was distilled by adding alkali to escape, and then absorbed by boric acid and titrated with a standard sulfuric acid solution to measure the nitrogen content. The crude protein content was calculated as:

$$Crude protein ( N ) = \frac{{k}_{N} {M}_{N} c ( V - {V}_{0} )}{m} \qquad ( 17 )$$

where k_{N} is average conversion coefficient of nitrogen into crude protein. M_{N} is molar mass of N, g/mol. c is concentration of acid standard solution, mol/L. V is volume of acid standard solution used to titrate the sample, mL. m is mass of sample, g.

Vitamins C: HPLC-MS/MS method (Agilent 1260 LC coupled to Xevo TQ-s mass spectrometer).

Vitamins E, chlorophyll and calcium: colorimetry method measured by a spectrophotometer.

### Energy conversion efficiency of WNCS

In the process of fog harvesting, the gravitational potential energy contained in the fog only was considered, so the energy conversion efficiency from fog to water droplets was the water collection efficiency of FWC. In the process of water droplets turning into electricity, the water droplets overcome electromagnetic induction and do work in the process of falling, thus realizing the conversion of gravitational potential energy. Therefore, the conversion efficiency of water droplets turning into electricity was calculated as:

$${η}_{d 2 e} = \frac{{E}_{e}}{{E}_{p}} = \frac{m g h}{\int U ( t ) I ( t ) dt} \qquad ( 18 )$$

where Eₚ is the gravitational potential energy of falling droplets during charging. Eₑ is the electrical energy generated per discharge, Ee=∫U(t)I(t)dt, U(t) and I(t) are the transient voltage and current during the discharge stage. Thirdly, in the process of electric nitrogen fixation, the energy released by electricity stimulates the synthesis of nitrogen dioxide. This energy conversion efficiency from electricity to chemical was calculated as:

$${η}_{e 2 c} = \frac{{E}_{c}}{{E}_{e}} \qquad ( 19 )$$

where Eₚ=M_{NO2} ΔH, M_{NO2} is the number of moles of NO₂ produced during one discharge, mol. ΔH is the reaction heat to generate 1 mol NO₂, which was about 67.8 KJ/mol.

### Calculation of Water and Nutrients Captured by Large-Scale WNCS

Approximately 1.79×1010 kg of water and approximately 1.56×108 kg of nitrogen fertilizer (nitrate) can be captured during the wheat growth cycle assuming the following: (1) all wheat fields in the world (230 million hectares) are equipped with a WNCS with a height of about 5m; (2) the front and rear rows of equipment are about 1 m apart; (3) the growing cycle of wheat is about 6 months; (4) there are 3 hours of fog every day; (5) the flow rate of fog is about 1300 g m⁻² h⁻¹; and (6) the yield of nitrate is about 0.0125 mg h⁻¹.

Wheat typically requires around 2-3 kg of nitrogen (N) per 100 kg of gain yield. Using an average value of 2.5 kg of nitrogen, producing 100 kg of wheat requires approximately 11.06 kg of nitrates to provide the required nitrogen. This amount may vary slightly depending on specific agricultural practices and the exact nitrogen requirements of the wheat variety being grown. The large-scale application of WNCS may therefore increase the global wheat production by about 1,407 kilotons per year.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or article that “comprises”, “has”, “includes” or “contains” one or more steps or elements possesses those one or more steps or elements, but is not limited to possessing only those one or more steps or elements. Likewise, a step of a method or an element of an article that “comprises”, “has”, “includes” or “contains” one or more features possesses those one or more features, but is not limited to possessing only those one or more features.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to an amount that is within ±10% of the recited value, an amount that is within ±5% of the recited value, less than or equal to ±2%, an amount that is within ±1% of the recited value, an amount that is within +0.5% of the recited value, an amount that is within ±0.2% of the recited value, an amount that is within ±0.1% of the recited value, or an amount that is within ±0.05% of the recited value. In some instances, the approximating language may correspond to the precision of an instrument for measuring the value.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present disclosure have been described and depicted herein, alternative aspects and embodiments may be affected by persons having ordinary skill in the art to accomplish the same objectives. Accordingly, this disclosure and the appended claims are intended to cover all such further and alternative aspects and embodiments as fall within the true spirit and scope of the present disclosure.

### REFERENCES

Carvalho, F. P. Pesticides, environment, and food safety. Food and Energy Security 6, 48-60 (2017).
WHO. Summary Progress Update 2021: SDG 6—water and sanitation for all. (2021).
FAO, I., UNICEF, WFP and WHO. The State of Food Security and Nutrition in the World 2023. 316 p. (2023).
Yang, D., Ramu, A. G. & Choi, D. Multifunctional integrated pattern for enhancing fog harvesting water unidirectional transport in a heterogeneous pattern. npj Clean Water 7, 20 (2024).
Pei, W. et al. Excellent fog harvesting performance of liquid-infused nano-textured 3D frame. Chemical Engineering Journal 409, 128180 (2021).
Zhang, S. et al. Bioinspired asymmetric amphiphilic surface for triboelectric enhanced efficient water harvesting. Nature Communications 13, 4168 (2022).
Li, J. et al. Aerodynamics-assisted, efficient and scalable kirigami fog collectors. Nature Communications 12, 5484 (2021). https://doi.org: 10.1038/s41467-021-25764-4
Feng, J., Zhong, L. & Guo, Z. Sprayed hieratical biomimetic superhydrophilic-superhydrophobic surface for efficient fog harvesting. Chemical Engineering Journal 388, 124283 (2020).
Lin, J., Tan, X., Shi, T., Tang, Z. & Liao, G. Leaf Vein-Inspired Hierarchical Wedge-Shaped Tracks on Flexible Substrate for Enhanced Directional Water Collection. ACS Applied Materials & Interfaces 10, 44815-44824 (2018).
Lekouch, I. et al. Dew, fog, and rain as supplementary sources of water in south-western Morocco. Energy 36, 2257-2265 (2011).
Park, K.-C., Chhatre, S. S., Srinivasan, S., Cohen, R. E. & Mckinley, G. H. Optimal Design of Permeable Fiber Network Structures for Fog Harvesting. Langmuir 29, 13269-13277 (2013).
Shi, W., Anderson, M. J., Tulkoff, J. B., Kennedy, B. S. & Boreyko, J. B. Fog Harvesting with Harps. ACS Applied Materials & Interfaces 10, 11979-11986 (2018).
Kaindu, J. K. et al. Antitangling and manufacturable Fog Harps for high-efficiency water harvesting. Droplet 2, e78 (2023).
Liu, Y. et al. Bioinspired Nanofibril-Humped Fibers with Strong Capillary Channels for Fog Capture. ACS Applied Materials & Interfaces 12, 28876-28884 (2020).
Tian, Y. et al. Large-scale water collection of bioinspired cavity-microfibers. Nature Communications 8, 1080 (2017).
Ju, J. et al. A multi-structural and multi-functional integrated fog collection system in cactus. Nature Communications 3, 1247 (2012).
Hou, Y. et al. Tunable Water Harvesting Surfaces Consisting of Biphilic Nanoscale Topography. ACS Nano 12, 11022-11030 (2018).
Parker, A. R. & Lawrence, C. R. Water capture by a desert beetle. Nature 414, 33-34 (2001).
Hung, D. V. et al. Measurements of particle size distributions produced by humidifiers operating in high humidity storage environments. Biosystems Engineering 107, 54-60 (2010).
Burgers, J. M. in Advances in Applied Mechanics Vol. 1 (eds Richard Von Mises & Theodore Von Kármán) 171-199 (Elsevier, 1948).
Dai, H., Dong, Z. & Jiang, L. Directional liquid dynamics of interfaces with superwettability. Science Advances 6, eabb5528.
Chini, S. F., Bertola, V. & Amirfazli, A. A methodology to determine the adhesion force of arbitrarily shaped drops with convex contact lines. Colloids and Surfaces A: Physicochemical and Engineering Aspects 436, 425-433 (2013).
Huang, H.-F. Voltage build-up time responses of Kelvin's water droplet generator: Variations due to different geometric configurations. Journal of Electrostatics 72, 447-456 (2014).
Zahn, M. Self-excited ac high voltage generation using water droplets. Am. J. Phys 41, 196-202 (1973).
Rigden, J. S. Macmillan Encyclopedia of Physics. (Simon & Schuster Macmillan, 1996).
Schrock, R. R. Reduction of dinitrogen. Proceedings of the National Academy of Sciences 103, 17087-17087 (2006).
Chen, J. G. et al. Beyond fossil fuel-driven nitrogen transformations. Science 360, eaar6611 (2018).
Wong, M.-C., Xu, W. & Hao, J. Microplasma-Discharge-Based Nitrogen Fixation Driven by Triboelectric Nanogenerator toward Self-Powered Mechano-Nitrogenous Fertilizer Supplier. Advanced Functional Materials 29, 1904090 (2019).
Van Alphen, S. et al. Effusion nozzle for energy-efficient NOx production in a rotating gliding arc plasma reactor. Chemical Engineering Journal 443, 136529 (2022).
Ponzio, F. et al. Oxidant Control of Polydopamine Surface Chemistry in Acids: A Mechanism-Based Entry to Superhydrophilic-Superoleophobic Coatings. Chemistry of Materials 28, 4697-4705 (2016).
Kresse, G. & Furthmüller, J. Efficient iterative schemes for ab initio total-energy calculations using a plane-wave basis set. Physical Review B 54, 11169-11186 (1996).
Perdew, J. P., Burke, K. & Ernzerhof, M. Generalized Gradient Approximation Made Simple. Physical Review Letters 77, 3865-3868 (1996).
Kresse, G. & Joubert, D. From ultrasoft pseudopotentials to the projector augmented-wave method. Physical Review B 59, 1758-1775 (1999).
Blöchl, P. E. Projector augmented-wave method. Physical Review B 50, 17953-17979 (1994).
Grimme, S., Antony, J., Ehrlich, S. & Krieg, H. A consistent and accurate ab initio parametrization of density functional dispersion correction (DFT-D) for the 94 elements H-Pu. The Journal of Chemical Physics 132 (2010).
Henkelman, G., Uberuaga, B. P. & Jónsson, H. A climbing image nudged elastic band method for finding saddle points and minimum energy paths. The Journal of Chemical Physics 113, 9901-9904 (2000).
Warncke, D. Nutrient Recommendations for Field Crops in Michigan. (2015).

What is claimed is:

1. A device comprising:
one or more fog harvesting units, said one or more fog harvesting units comprising a polymer material;
wherein each fog harvesting unit comprises a frame, said frame having a hollow cylinder shape; and
wherein the frame further comprises spikes, said spikes having a surface.

2. The device of claim 1, wherein the spikes have a width of about 1 mm and a length of about 10 mm.

3. The device of claim 1, wherein the surface of the spikes comprises a patterned structure.

4. The device of claim 3, wherein the polymer material is hydrophobic and the patterned structure is a hydrophilic patterned structure, said hydrophilic patterned structure comprising a hydrophilic material.

5. The device of claim 3, wherein the polymer material is hydrophilic and the patterned structure is a hydrophobic patterned structure, said hydrophobic patterned structure comprising a hydrophobic material.

6. The device of claim 3, wherein the patterned structure is a geometric pattern, said geometric pattern is a circular pattern and/or a triangular pattern; and wherein adjacent geometric patterns are separated by about 1.1 mm to about 3.0 mm.

7. The device of claim 4, wherein the hydrophobic contact angle is greater than 90° and the hydrophilic contact angle is less than 90°.

8. The device of claim 1, further comprising:
an electricity generator; and
a discharge reactor.

9. The device of claim 8, wherein the electricity generator comprises a Kelvin water dropper having two conductive containers and two conductive rings.

10. The device of claim 8, wherein the discharge reactor:
(i) facilitates nitrogen fixation through high voltage electric breakdown in the air, thereby converting nitrogen into nitrogen oxides; and
(ii) generates nitrate that dissolves in water, thereby providing nutrients for plant growth.

11. A system comprising:
a water harvester configured to collect fog, said water harvester comprising one or more fog harvesting units and optionally a water tank;
an electricity generator configured to harness the gravitational potential energy of water droplets and the triboelectric effect to generate electricity; and
a discharge reactor configured to receive water and energy from the electricity generator and to achieve nitrogen conversion, promoting plant germination and growth.

12. The system of claim 11, wherein a fog harvesting unit comprises:
a frame, said frame comprising a surface;
wherein the frame is open to the passage of air; and
wherein the surface of the frame comprises a patterned structure.

13. The system of claim 12, wherein the frame comprises a hydrophobic polymer material and the patterned structure comprises a hydrophilic material.

14. The system of claim 13, wherein the patterned structure comprises one or more geometric patterns; said one or more geometric patterns comprising a circular pattern, a triangular pattern, or a combination thereof; and wherein the one or more geometric patterns are spaced apart by about 0.5 mm.

15. The system of claim 14, wherein the hydrophobic contact angle is greater than 90° and the hydrophilic contact angle is less than 90°.

16. The system of claim 11, wherein the electricity generator comprises a Kelvin water dropper having two conductive containers and two conductive rings.

17. The system of claim 11, wherein the discharge reactor:
(i) facilitates nitrogen fixation through high voltage electric breakdown in the air, thereby converting nitrogen into nitrogen oxides; and
(ii) generates nitrate that dissolves in water, thereby providing nutrients for plant growth.

18. The system of claim 12, wherein the frame comprises:
a hollow cylinder shape; and
a plurality of spikes;
wherein a surface of the plurality of spikes comprises a hydrophilic patterned structure, said hydrophilic patterned structure comprising one or more geometric patterns, said one or more geometric patterns comprising a circular pattern, a triangular pattern, or a combination thereof;
and wherein the one or more geometric patterns are spaced apart by about 0.5 mm.

19. The system of claim 18, wherein the hydrophobic contact angle is greater than 90° and the hydrophilic contact angle is less than 90°.

20. The system of claim 10, wherein the water harvester comprises employs a modular design comprised of multiple fog harvesting units, allowing adaptability to various scales of mist collection.
